(19) United States
(12) Patent Application Publication
(10) Pub. No.: US 2024/0346235 A1
(43) Pub. Date: Oct. 17, 2024

(54) CONTEXT-AWARE EDIT MANAGEMENT OF WEBPAGE-BASED APPLICATIONS

(71) Applicant: International Business Machines Corporation, Armonk, NY (US)

(72) Inventors: Odellia Boni, Giva'at Ela (IL); Michal Shmueli-Scheuer, Tel-Aviv (IL); Kshitij Fadnis, Astoria, NY (US); Pankaj Dhoolia, Ghaziabad (IN)

(21) Appl. No.: 18/300,813

(22) Filed: Apr. 14, 2023

(51) Int. Cl. G06F 40/166; G06F 16/23; G06F 16/958; G06F 40/14; G06F 40/197; G06F 40/30

(52) U.S. Cl. CPC G06F 40/166; G06F 16/2365; G06F 16/986; G06F 40/14; G06F 40/197; G06F 40/30

(57) ABSTRACT

Systems and techniques that facilitate context-aware edit management of webpage-based applications are provided. In various embodiments, a system can detect an edit made to a webpage. In various aspects, the system can determine whether a webpage-based application associated with the webpage is consistent with the edit, based on a registry that respectively maps outputs of the webpage-based application to source texts and corresponding semantic contexts of a pre-edit version of the webpage.

### BACKGROUND

The subject disclosure relates to webpage-based applications, and more specifically to context-aware edit management of webpage-based applications.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate context-aware edit management of webpage-based applications are described.

According to one or more embodiments, a system is provided. In various aspects, the system can comprise a processor that can execute computer-executable components stored in a non-transitory computer-readable memory. In various instances, the computer-executable components can comprise a detection component that can detect an edit made to a webpage. In various cases, the computer-executable components can comprise a consistency component that can determine whether a webpage-based application associated with the webpage is consistent with the edit, based on a registry that respectively maps outputs of the webpage-based application to source texts and corresponding semantic contexts of a pre-edit version of the webpage.

According to various embodiments, the above-described system can be implemented as a computer-implemented method or as a computer program product.

### DESCRIPTION OF THE DRAWINGS

FIG. 1 illustrates a block diagram of an example, non-limiting system that facilitates context-aware edit management of webpage-based applications in accordance with one or more embodiments described herein.

FIG. 2 illustrates an example, non-limiting block diagram of a document object model tree of a webpage and of a set of outputs of a webpage-based application in accordance with one or more embodiments described herein.

FIG. 3 illustrates a block diagram of an example, non-limiting system including an edit that facilitates context-aware edit management of webpage-based applications in accordance with one or more embodiments described herein.

FIG. 4 illustrates a block diagram of an example, non-limiting system including a text-context registry and a set of consistency determinations that facilitates context-aware edit management of webpage-based applications in accordance with one or more embodiments described herein.

FIG. 5 illustrates an example, non-limiting block diagram of a text-context registry in accordance with one or more embodiments described herein.

FIGS. 6-7 illustrate example, non-limiting block diagrams showing how a text-context registry can be leveraged to determine whether or not a webpage-based application is consistent with an edit of a webpage in accordance with one or more embodiments described herein.

FIGS. 8-11 illustrate, in example, non-limiting fashion, how various aspects can be applied to real-world webpages in accordance with one or more embodiments described herein.

FIG. 12 illustrates a block diagram of an example, non-limiting system including an electronic alert that facilitates context-aware edit management of webpage-based applications in accordance with one or more embodiments described herein.

FIGS. 13-16 illustrate flow diagrams of example, non-limiting computer-implemented methods that facilitate context-aware edit management of webpage-based applications in accordance with one or more embodiments described herein.

FIG. 17 illustrates a flow diagram of an example, non-limiting computer-implemented method that facilitates context-aware edit management of webpage-based applications in accordance with one or more embodiments described herein.

FIG. 18 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A webpage can be any suitable structured electronic document that is displayable or viewable by a web browser (e.g., Chrome, Firefox, Safari, Edge, or Internet Explorer). The structure, organization, or substantive content (e.g., textual content, image content, audio content) of the webpage can be hierarchically represented by a document object model (DOM) tree. The DOM tree can be any suitable logical tree of nested document objects, where each document object can be or otherwise define a specific part, portion, element, or building block of the webpage (e.g., can be or define a section of the webpage, a sub-section of the webpage, a paragraph of the webpage, a drop-down menu of the webpage, or an ordered list of the webpage). The DOM tree of the webpage can be written or otherwise expressed in any suitable computing syntax (e.g., Hypertext Markup Language (HTML), Extensible Markup Language (XML)).

There can be a webpage-based application that corresponds to or is otherwise associated with the webpage. The webpage-based application can be any suitable software program that can provide outputs in response to user inputs, where the outputs can be based at least in part on the textual content of the webpage. In some cases, the outputs can be preformulated or prefabricated based on the textual content of the webpage. In other cases, the output can be generated in real-time (e.g., such as via generative artificial intelligence or real-time searching or text extraction) based on the textual content of the webpage.

As a non-limiting example, the webpage-based application can be a chatbot that can textually converse with a client who visits the webpage, using a set of textual responses that are based on (e.g., preformulated from or extracted in real-time from) sentences, sentence fragments, or words present within the webpage. In such case, the chatbot can prompt the client for inputted textual information (e.g., the chatbot can ask the client one or more premade questions, and the client can type or select answers to those one or more premade questions). Based on the inputted textual information from the client (e.g., based on the answers typed or selected by the client), the chatbot can identify one or more of the set of textual responses that are pertinent to the client, and the chatbot can return to the client those one or more identified textual responses.

Periodically or aperiodically, the textual content of the webpage can be changed, altered, updated, or otherwise edited by a technician overseeing or maintaining the webpage or the webpage-based application. In some cases, such edits to the textual content of the webpage can render the outputs of the webpage-based application obsolete or inaccurate. In such cases, commensurate edits to the webpage-based application can be warranted. However, in other cases, such edits to the textual content of the webpage can be irrelevant to the outputs of the webpage-based application. In such cases, no commensurate edits to the webpage-based application can be warranted. Accordingly, there can be a need for determining whether or not an edit made to the webpage warrants a commensurate edit being made to the webpage-based application.

Some existing techniques for facilitating such determination involve constructing a registry that respectively links or correlates the outputs of the webpage-based application with whatever pre-edit source texts (e.g., with whatever pre-edit paragraphs, pre-edit sentences, or pre-edit sentence fragments) of the webpage from which such outputs were or are derived. When an edit is made to the textual content of the webpage, such existing techniques determine, via text matching, whether or not each pre-edit source text is still present within the webpage. If each pre-edit source text is still present within the webpage, such existing techniques conclude that the edit did not render obsolete or inaccurate the outputs of the webpage-based application. In contrast, if at least one pre-edit source text is no longer present within the webpage, such existing techniques conclude that the edit rendered obsolete or inaccurate at least one output of the webpage-based application. As the inventors of various embodiments described herein recognized, such existing techniques fail in situations where a pre-edit source text is repeated in different locations within the webpage.

For example, suppose that the webpage has a section A dealing with some substantive topic and a section B dealing with some different substantive topic. Furthermore, suppose that a given output of the webpage-based application pertains to the topic of section A but not to the topic of section B. Accordingly, the given output can be derived from or based on a given pre-edit source text that is written in section A. Note that it is possible that identical text is also written in section B, notwithstanding that the given output does not pertain to the topic of section B. Now, the webpage can be edited, such that the given pre-edit source text is no longer present in section A but such that its identical language is still present within section B. Such edit can be considered as a substantive textual change that renders the given output obsolete or inaccurate. However, existing techniques that rely on text matching alone would fail to flag such obsolescence or inaccuracy, since identical language is still present within section B. Thus, existing techniques that rely upon text matching alone can be considered as disadvantageous.

Other existing techniques for determining whether or not an edit to the webpage warrants a commensurate edit to the webpage-based application involve constructing a registry that respectively links or correlates the outputs of the webpage-based application with their pre-edit source texts and with whatever pre-edit Xpaths correspond to (e.g., with whatever ordered sequences of DOM tags lead to) those pre-edit source texts. When an edit is made to the textual content of the webpage, such existing techniques determine, via text matching, whether or not each pre-edit source text is still present within the webpage at its respective pre-edit Xpath. If each pre-edit source text is still present within the webpage at its respective pre-edit Xpath, such existing techniques conclude that the edit did not render obsolete or inaccurate the outputs of the webpage-based application. On the other hand, if at least one pre-edit source text is no longer present within the webpage at its respective pre-edit Xpath, such existing techniques conclude that the edit rendered obsolete or inaccurate at least one output of the webpage-based application. Such existing techniques can address situations in which pre-edit source texts are repeated throughout the webpage (e.g., repeated instances of a pre-edit source text can have distinct Xpaths). However, as the present inventors recognized, such existing techniques can fail in situations where the edit substantively maintains a pre-edit source text but alters its Xpath via an ordering change, a tag change, or a style change.

For example, suppose that a specific output of the webpage-based application is derived from or based on a specific pre-edit source text of the webpage that has a specific pre-edit Xpath. For instance, the specific pre-edit Xpath can be: [<webpage>, <body>, <div>(2), <p>, <ul>, <i>(3)]. This specific pre-edit Xpath can indicate that the specific pre-edit source text is located in a third item of a first unordered list of a first paragraph of a second section (e.g., second division) of a body of the webpage.

Now, suppose that the webpage is edited, such that the specific pre-edit source text is no longer within the first paragraph of the second section, but is instead within a fourth paragraph of the second section. That is, the edit can have maintained the specific pre-edit source text but can have changed its Xpath to: [<webpage>, <body>, <div>(2), <p>(4), <ul>, <i>(3)]. Such edit can be considered as a mere nesting order change and thus as not rendering the specific output obsolete or inaccurate. However, existing techniques that utilize Xpath comparison would falsely conclude that the specific output is now obsolete or inaccurate, since the specific pre-edit source text is no longer located at the specific pre-edit Xpath.

As another instance, suppose that the webpage is edited, such that the unordered list housing the specific pre-edit source text is changed to an ordered list. That is, the edit can have maintained the specific pre-edit source text but can have changed its Xpath to: [<webpage>, <body>, <div>(2), <p>, <ol>, <i>(3)]. Such edit can be considered as a mere tag change and thus as not rendering the specific output obsolete or inaccurate. However, existing techniques that utilize Xpath comparison would falsely conclude that the specific output is now obsolete or inaccurate, since the specific pre-edit source text is no longer located at the specific pre-edit Xpath.

As yet another instance, suppose that the webpage is edited, such that the pre-edit source text is bolded. That is, the edit can have maintained the specific pre-edit source text but can have changed its Xpath to: [<webpage>, <body>, <div>(2), <p>, <ul>, <i>(3), <b>]. Such edit can be considered as a mere styling change and thus as not rendering the specific output obsolete or inaccurate. However, existing techniques that utilize Xpath comparison would falsely conclude that the specific output is now obsolete or inaccurate, since the specific pre-edit source text is no longer located at the specific pre-edit Xpath.

Accordingly, existing techniques that rely upon Xpath comparison can be considered as disadvantageous.

Moreover, as the present inventors recognized, existing techniques that rely upon Xpath comparison can also fail in situations where the edit changes substantive textual content of document objects within which pre-edit source texts are nested without changing their Xpaths. For example, suppose that a particular output of the webpage-based application is derived from or based on a particular pre-edit source text that has a particular pre-edit Xpath. For instance, the particular pre-edit Xpath can be: [<webpage>, <body>, <div>, <p>(2), <ol>, <i>]. This particular pre-edit Xpath can indicate that the particular pre-edit source text is located in a first item of a first ordered list of a second paragraph of a first section of a body of the webpage.

Now, suppose that the first section pertains to a first substantive topic. In various aspects, the webpage can be edited, such that the particular pre-edit source text is still located in the first item of the first ordered list of the second paragraph of the first section of the body of the webpage, but such that the first section has been heavily textually edited to no longer pertain to the first substantive topic. Accordingly, the Xpath of the particular pre-edit source text has not changed, but the particular pre-edit source text might no longer be substantively pertinent to the particular output (e.g., the particular output was based on the first section of the webpage when the first section pertained to the first substantive topic, but the first section no longer pertains to the first substantive topic). Such edit can be considered as a substantive textual change that renders the particular output obsolete or inaccurate. However, existing techniques that utilize Xpath comparison would fail to flag such obsolescence or inaccuracy, since the particular pre-edit Xpath has not been changed. Again, existing techniques that rely upon Xpath comparison can be considered as disadvantageous.

For at least these reasons, existing techniques for determining whether or not an edit to the webpage warrants a commensurate edit to the webpage-based application can be considered as suffering from various technical problems. Accordingly, systems or techniques that can address one or more of these technical problems can be desirable.

Various embodiments described herein can address one or more of these technical problems. Specifically, various embodiments described herein can facilitate context-aware edit management of webpage-based applications. In particular, various embodiments described herein can involve constructing or maintaining a registry that links defined outputs of the webpage-based application to pre-edit source texts and also to semantic contexts of those pre-edit source texts. As described herein, a semantic context of a pre-edit source text can be considered as a chain of text strings, where such text strings can respectively come from or otherwise be based on textual contents of whatever document objects within which the pre-edit source text is nested. In other words, the semantic context of the pre-edit source text can be considered as indicating, conveying, or otherwise representing at least some of the textual content of those document objects. In stark contrast, an Xpath of the pre-edit source text would instead be an ordered sequence of DOM tags indicating which document objects the pre-edit source text is nested in, without regard to the textual content of those document objects. That is, a semantic context can be distinct from an Xpath (e.g., there can be situations in which an Xpath can remain unchanged while a semantic context changes; there can be other situations in which an Xpath can change while a semantic context remains unchanged).

For example, suppose that a given pre-edit source text has the following Xpath: [<webpage>, <body>, <div>(3), <p>, <ol>, <i>(2)]. This can indicate that the given pre-edit source text is located in a second item of a first ordered list of a first paragraph of a third section of a body of the webpage. Note that the Xpath does not indicate, in any way, any textual content that might be within the first ordered list but outside of the second item, any textual content that might be within the first paragraph but outside of the first ordered list, any textual content that might be within the third section but outside of the first paragraph, any textual content that might be within the body of webpage but outside of the third section, or any textual content that might be within the webpage but outside of the body.

In stark contrast to the Xpath, a semantic context of that give pre-edit source text can be an ordered chain of text strings. In various aspects, a first text string in such ordered chain can be based on whatever textual content (if any) is written within the webpage but outside of the body of the webpage (e.g., in <webpage> but outside of <body>). In various instances, a second text string in such ordered chain can be based on whatever textual content (if any) is written within the body of the webpage but outside of the third section of the body (e.g., in <body> but outside of <div>(3)). In various cases, a third text string in such ordered chain can be based on whatever textual content (if any) is written within the third section but outside of the first paragraph of the third section (e.g., in <div>(3) but outside of <p>). In various aspects, a fourth text string in such ordered chain can be based on whatever textual content (if any) is written within the first paragraph but outside of the first ordered list of the first paragraph (e.g., in <p> but outside of <ol>). In various instances, a fifth text string in such ordered chain can be based on whatever textual content (if any) is written within the first ordered list but outside of the second item of the first ordered list (e.g., in <ol> but outside of <i>(2)).

Now, suppose that the edit to the webpage changes the textual content of the first paragraph of the third section of the body of the webpage. In such case, the Xpath of the given pre-edit source text can be unaffected by the edit, but the semantic context of the given pre-edit source text can be changed by the edit (e.g., the fourth text string mentioned above can be altered by such edit).

In contrast, suppose that the edit to the webpage changes a nesting order, a tag type, or an aesthetic style of any of the document objects in which the given pre-edit source text is nested, without altering the textual contents of those document objects. In such case, the semantic context of the given pre-edit source text can be unaffected by the edit, but the Xpath of the given pre-edit source text can be changed by the edit.

In any case, the present inventors realized that it can be more accurately or reliably determined whether or not an edit to a webpage warrants a commensurate edit to a webpage-based application, by leveraging semantic context comparison instead of (or in addition to, in some cases) Xpath comparison.

Various embodiments described herein can be considered as a computerized tool (e.g., any suitable combination of computer-executable hardware or computer-executable software) that can facilitate context-aware edit management of webpage-based applications. In various aspects, such a computerized tool can comprise a detection component, a consistency component, or an alert component.

In various embodiments, there can be a webpage. In various aspects, the webpage can be any suitable electronic document that is displayable or viewable by a web browser. In various instances, a hierarchical structure of the webpage can be expressed or represented by a DOM tree. In various cases, the DOM tree can be written in any suitable syntax, such as HTML or XML.

In various aspects, the webpage can correspond to or otherwise be associated with a webpage-based application. In various instances, the webpage-based application can be any suitable computer program, such as a chatbot, that can provide to a client who visits the webpage one or more of a set of outputs, where each of the set of outputs can be based on respective textual content written within the webpage.

In various cases, it can be desired to perform an edit on the webpage. In some instances, such edit can substantively alter the textual content on which one or more outputs of the webpage-based application are based or derived. In such case, such edit can be considered as rendering those outputs obsolete or incorrect. In other instances, however, such edit can instead refrain from substantively altering the textual content on which the outputs of the webpage-based application are based or derived. In such case, such edit can be considered as not rendering those outputs obsolete or incorrect. For any given edit, it can be desired to determine whether or not such edit has rendered the outputs of the webpage-based application obsolete or incorrect. In various aspects, the computerized tool described herein can facilitate such determination.

In various embodiments, the detection component of the computerized tool can electronically detect an edit that is made to the webpage. More specifically, the detection component can electronically receive, retrieve, or otherwise access (e.g., via the Internet) the webpage, its DOM tree, or the webpage-based application, such that the detection component can electronically interact with (e.g., read, write, edit, copy, manipulate) the webpage, its DOM tree, or the webpage-based application. Accordingly, in various aspects, the detection component can continuously, continually, periodically, or aperiodically monitor the webpage or its DOM tree for edits that are made by technicians or software engineers. In various instances, the detection component can facilitate such monitoring via any suitable webpage edit detection technique, such as a Delta technique based on fuzzy tree differences or such as an HTML digest comparison technique. In any case, a technician or software engineer who is tasked with maintaining or updating the webpage can make an edit to the webpage or to its DOM tree, and the detection component can electronically detect that such edit has occurred.

In various embodiments, the consistency component of the computerized tool can electronically determine whether or not the webpage-based application is consistent with the detected edit, by leveraging a text-context registry that is associated with the webpage and with the webpage-based application.

More specifically, in various aspects, the text-context registry can include a set of pre-edit source texts that respectively correspond to the set of outputs, and the text-context registry can also include a set of pre-edit semantic contexts that respectively correspond to the set of pre-edit source texts. In various instances, a pre-edit source text can be any suitable textual content written somewhere within the webpage prior to occurrence of the detected edit and from which a respective one of the set of outputs is based, derived, or sourced. In other words, a pre-edit source text can be considered as being a piece of reference text within a pre-edit version of the webpage that justifies or demonstrates the correctness of a respective output. In various cases, a pre-edit semantic context can be an ordered chain of text strings, where such text strings can be based on whatever textual contents are written within the document objects inside which a respective pre-edit source text is nested (or, at least, was nested prior to occurrence of the detected edit). As a non-limiting example, a text string in the chain can be a full or partial copy of textual content from a respective one of those document objects. As another non-limiting example, a text string in the chain can be a summary of textual content from a respective one of those document objects. As yet another non-limiting example, a text string in the chain can be a title or header of a respective one of those document objects.

In various aspects, the consistency component can, in response to the detected edit, electronically iterate through each of the set of outputs. For any given output, the consistency component can electronically determine whether the given output is consistent with the detected edit, by leveraging the text-context registry. In particular, the consistency component can identify, via the text-context registry, whichever pre-edit source text and pre-edit semantic context correspond to the given output. In various instances, the consistency component can check, via text matching or semantic similarity comparison, whether the identified pre-edit source text is still present within the webpage after occurrence of the detected edit.

Suppose that the consistency component determines that the identified pre-edit source text is still present within the webpage after occurrence of the detected edit. In various aspects, for each instance or copy of the identified pre-edit source text that the consistency component locates within the webpage, the consistency component can identify a respective post-edit semantic context, by traversing the DOM tree of the webpage (after occurrence of the detected edit) backwards from each instance or copy of the identified pre-edit source text. In various cases, the consistency component can check, via text matching or semantic similarity comparison, whether any of those post-edit semantic contexts matches the identified pre-edit semantic context. If at least one of those post-edit semantic contexts matches the identified pre-edit semantic context, then the consistency component can conclude that the given output is consistent with the edit (e.g., can conclude that the edit has not rendered the given output obsolete or incorrect). On the other hand, if none of those post-edit semantic contexts matches the identified pre-edit semantic context, then the consistency component can conclude that the given output is context-inconsistent with the edit (e.g., can conclude that the edit has caused the identified pre-edit source text to have some new or different semantic context).

Now, instead suppose that the consistency component determines that the identified pre-edit source text is no longer present within the webpage after occurrence of the detected edit. In various aspects, the consistency component can determine, via text parsing, whether there is any other source text (e.g., whether there are any other paragraphs, sentences, sentence fragments, or words) within the webpage after occurrence of the detected edit that has the identified pre-edit semantic context. If at least some other source text that is present in the webpage after occurrence of the detected edit has the identified pre-edit semantic context, then the consistency component can conclude that the given output is source-inconsistent with the edit (e.g., can conclude that the edit has caused the identified pre-edit semantic context to be associated with some new or different textual content). In contrast, if no other source text that is present in the webpage after occurrence of the detected edit has the identified pre-edit semantic context, then the consistency component can conclude that the given output is both source-inconsistent and context-inconsistent with the edit (e.g., can conclude that the edit has removed both the identified pre-edit source text and the identified pre-edit semantic context from the webpage).

In this way, the consistency component can produce, generate, or otherwise make a consistency determination for each of the set of outputs of the webpage-based application.

In various embodiments, the alert component of the computerized tool can electronically generate an alert based on the consistency determinations. In various aspects, the alert can be any suitable electronic message or electronic warning that can list or otherwise convey any of the consistency determinations. In other words, the alert can be considered as any suitable electronic message or electronic warning that can indicate or otherwise specify which, if any, of the set of outputs is consistent with the detected edit or is inconsistent (e.g., source-inconsistent, context-inconsistent, or both) with the detected edit. In various instances, the alert component can electronically render the alert on any suitable electronic display. In various other instances, the alert component can electronically transmit the alert to any other suitable computing device. Accordingly, a technician or software engineer who is tasked with overseeing or maintaining the webpage or the webpage-based application can read or view the alert, so as to become aware of which outputs of the webpage-based application, if any, warrant commensurate edits.

Various embodiments described herein can be employed to use hardware or software to solve problems that are highly technical in nature (e.g., to facilitate context-aware edit management of webpage-based applications), that are not abstract and that cannot be performed as a set of mental acts by a human. Further, some of the processes performed can be performed by a specialized computer (e.g., DOM tree parsers). In various aspects, some defined tasks associated with various embodiments described herein can include: detecting, by a device operatively coupled to a processor, an edit made to a webpage; and determining, by the device, whether a webpage-based application associated with the webpage is consistent with the edit, based on a registry that respectively maps outputs of the webpage-based application to source texts and corresponding semantic contexts of a pre-edit version of the webpage.

Neither the human mind nor a human with pen and paper can electronically detect an edit made to a webpage and can electronically determine whether or not a webpage-based application (e.g., a chatbot) is consistent with the edit by leveraging a registry that correlates outputs of the webpage-based application to pre-edit source texts and pre-edit semantic contexts of the webpage. After all, a webpage is a structured electronic document (e.g., written in HTML or XML) that can be displayed by a web browser. In other words, a webpage is an inherently computerized construct which neither the human mind, nor a human with pen and paper, can meaningfully implement. Likewise, a webpage-based application is an automated software program, such as a chatbot, that can interact with clients that visit the webpage. Again, a webpage-based application is an inherently computerized construct which neither the human mind, nor a human with pen and paper, can meaningfully implement. Accordingly, a computerized tool that can automatically monitor a webpage for edits and that can automatically determine whether or not a related webpage-based application is consistent with those edits is inherently computerized and cannot be implemented in any sensible, practicable, or reasonable way without computers.

In various instances, one or more embodiments described herein can integrate the herein-described teachings into a practical application. As mentioned above, some existing techniques for determining whether or not an edit to a webpage warrants a commensurate edit to a webpage-based application rely upon text matching. Unfortunately, such existing techniques fail in situations where source texts are repeated two or more times throughout the webpage. As also mentioned above, other existing techniques for determining whether or not an edit to a webpage warrants a commensurate edit to a webpage-based application rely upon Xpath comparisons in conjunction with text matching. Such existing techniques can avoid failing in situations where source texts are repeated two or more times throughout the webpage. However, such existing techniques nevertheless fail in situations where Xpaths change (e.g., due to nesting order, tag type, or style) without the textual substance of source texts changing.

Various embodiments described herein can address one or more of these technical problems. In particular, to address the shortcomings of text-matching techniques and Xpath-comparison techniques, the present inventors devised the concept of semantic context. As explained above, when given any source text within a webpage, the semantic context of that given source text can be a chain of text strings, where each text string can be based on (e.g., can be a snippet from, can be a summary of, can be a header or title of) textual content from a respective document object that the given source text is nested within. Contrast this with an Xpath of the given source text, which would only indicate the nesting order, tag types, or aesthetic styles of the document objects within which the given source text is nested, without regard to the textual content of those document objects.

In various aspects, the present inventors realized that more accurate or more reliable determinations regarding whether an edit to the webpage warrants a commensurate edit to the webpage-based application can be made when semantic context comparison is utilized instead of (or in addition to) Xpath comparison. As an example, there can be edits that change the semantic context of a given source text without changing the Xpath of that given source text. Existing techniques would fail to flag such edits as being inconsistent with the webpage-based application, whereas various embodiments described herein would not fail in such way. As another example, there can be edits that change the Xpath of a given source text without changing the semantic context of that given source text. Existing techniques would mistakenly or erroneously flag such edits as being inconsistent with the webpage-based application, whereas various embodiments described herein would not make such mistake or error. In other words, the implementation of semantic context is a concrete and tangible technical improvement in the field of webpage-based applications. In still other words, various embodiments described herein can be considered as outperforming various existing techniques (e.g., as not failing in situations in which such existing techniques would fail). For at least these reasons, various embodiments described herein certainly constitute useful and practical applications of computers.

It should be appreciated that the figures and the herein disclosure describe non-limiting examples of various embodiments. It should further be appreciated that the figures are not necessarily drawn to scale.

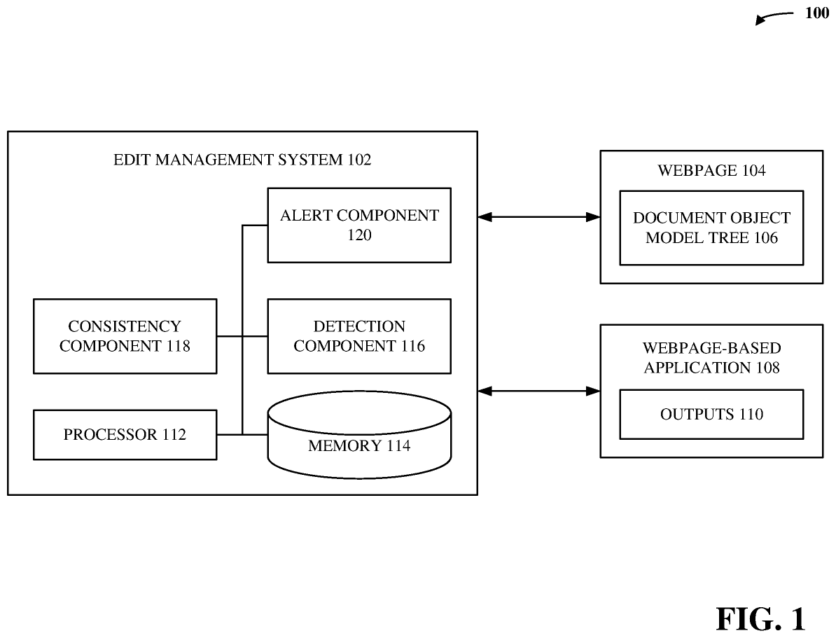

FIG. 1 illustrates a block diagram of an example, non-limiting system 100 that can facilitate context-aware edit management of webpage-based applications in accordance with one or more embodiments described herein. As shown, an edit management system 102 can be electronically integrated, via any suitable wired or wireless electronic connections, with a webpage 104 or with a webpage-based application 108.

In various embodiments, the webpage 104 can be any suitable webpage of any suitable website. That is, the webpage 104 can be any suitable structured electronic document that can be displayed, rendered, visited, or otherwise interacted with via any suitable web browser. In various aspects, the webpage 104 can exhibit or otherwise contain any suitable substantive content that can be rendered or otherwise played by the web browser. As a non-limiting example, the webpage 104 can contain any suitable textual content (e.g., one or more paragraphs, one or more sentences, one or more sentence fragments, one or more words, or any suitable combination thereof) that can be visually displayed on a computer screen by a web browser. As another non-limiting example, the webpage 104 can contain any suitable image content (e.g., one or more two-dimensional pixel arrays, one or more three-dimensional voxel arrays, or any suitable combination thereof) that can be visually displayed on a computer screen by a web browser. As yet another non-limiting example, the webpage 104 can contain any suitable audio content (e.g., one or more audio files, one or more sound waveforms, or any suitable combination thereof) that can be audibly played on a computer speaker by a web browser.

In any case, the webpage 104 can comprise a document object model tree 106 (hereafter “DOM tree 106”). In various aspects, the DOM tree 106 can represent or otherwise indicate a hierarchical structure or organization of the webpage 104. More specifically, the DOM tree 106 can be a logical tree of nested document objects, where each document object can be any suitable discrete or definable portion or element of the webpage 104. As a non-limiting example, a document object can be or otherwise define a section (e.g., <div>) of the webpage 104. As another non-limiting example, a document object can be or otherwise define a sub-section (e.g., <div> within <div>) of the webpage 104. As yet another non-limiting example, a document object can be or otherwise define a paragraph (e.g., <p>) of the webpage 104. As even another non-limiting example, a document object can be or otherwise define a list (e.g., <ol>, <ul>) within the webpage 104. As still another non-limiting example, a document object can be or otherwise define an item (e.g., <i>) within a list of the webpage 104. In any case, the DOM tree 106 can be expressed in any suitable computing syntax. As a non-limiting example, the DOM tree 106 can be expressed in HTML (e.g., in such case, the webpage 104 can be considered as an HTML document). As another non-limiting example, the DOM tree 106 can be expressed in XML (e.g., in such case, the webpage 104 can be considered as an XML document).

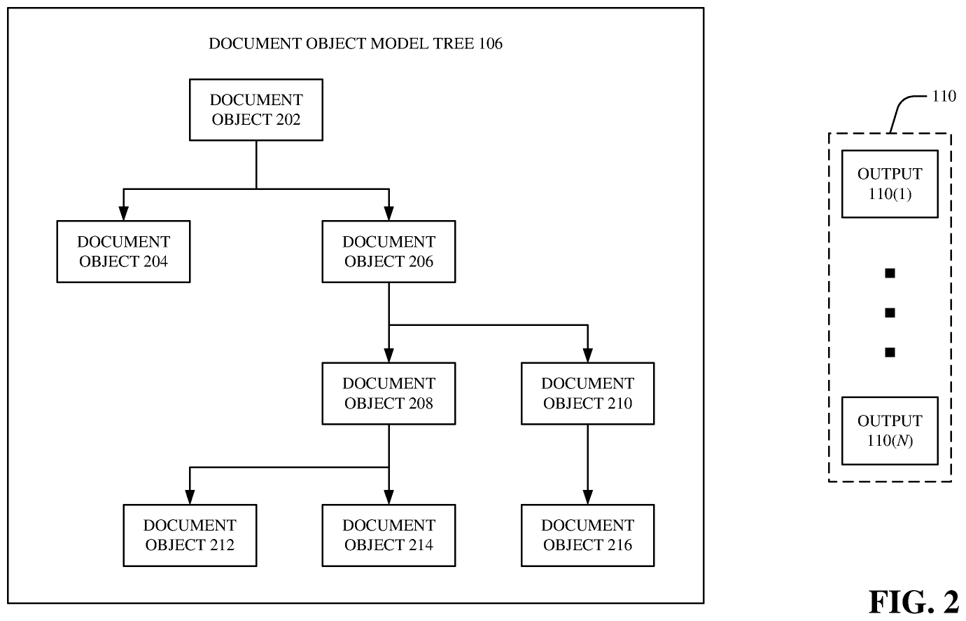

Various non-limiting aspects of the DOM tree 106 are described with respect to FIG. 2. As shown, FIG. 2 illustrates an example, non-limiting embodiment of the DOM tree 106. In various aspects, the DOM tree 106 can comprise a document object 202. In various instances, the document object 202 can be considered as a root node of the DOM tree 106. That is, the document object 202 can be considered as representing, in umbrella-like fashion, an entirety or totality of the webpage 104.

In various cases, as shown, there can be a document object 204 and a document object 206 nested within or under the document object 202. In various aspects, the document object 204 can be considered as a metadata node of the webpage 104. Accordingly, the document object 204 can, in various instances, contain, express, convey, or otherwise specify any suitable metadata pertaining to the webpage 104. As some non-limiting examples, the document object 204 can specify an author or publisher of the webpage 104, a version identifier of the webpage 104, an encoding of the webpage 104, or a date of creation of the webpage 104. In contrast, the document object 206 can be considered as a body node of the webpage 104. That is, the document object 206 can, in various cases, contain, express, convey, or otherwise specify any suitable substantive content or payload information of the webpage 104.

In various instances, there can be a document object 208 and a document object 210 nested within or under the document object 206. In various cases, the document object 208 and the document object 210 can be considered as distinct sections (e.g., distinct instances of <div>) of the webpage 104. That is, the document object 208 can be considered as a first section (e.g., pertaining to a first substantive topic) of the body of the webpage 104, and the document object 208 can be considered as a second section (e.g., pertaining to a second substantive topic) of the body of the webpage 104.

In various aspects, there can be a document object 212 and a document object 214 nested within or under the document object 208. In various instances, the document object 212 and the document object 214 can be considered as distinct paragraphs (e.g., distinct instances of <p>) of the first section of the webpage 104. Likewise, there can be a document object 216 nested within or under the document object 210. Similar to above, the document object 216 can be a paragraph (e.g., <p>) of the second section of the webpage 104.

Although FIG. 2 depicts the DOM tree 106 as having eight document objects in total, this is a mere non-limiting example for ease of explanation and illustration. In various aspects, the DOM tree 106 can comprise any suitable number of any suitable types of document objects which can be hierarchically nested within each other in any suitable arrangement, order, or nesting depth.

Although not shown in FIG. 2 for sake of space and clarity, any document object in the DOM tree 106 can contain, indicate, or otherwise specify any suitable textual content which can be visually rendered or displayed by a web browser. As a non-limiting example, the document object 202 can be the root node of the DOM tree 106, and so the document object 202 can have or specify as textual content a title of the webpage 104. As another non-limiting example, the document object 204 can be a metadata node of the DOM tree 106, and so the document object 204 can have or specify as textual content an author, a version identifier, or a date of creation of the webpage 104. As yet another non-limiting example, the document object 208 can be a first section of the body of the webpage 104, and so the document object 208 can have or specify as textual content a title or header of the first section of the webpage 104. As still another non-limiting example, the document object 210 can be a second section of the body of the webpage 104, and so the document object 210 can have or specify as textual content a title or header of the second section of the webpage 104. As even another non-limiting example, the document object 212 and the document object 214 can be first and second paragraphs of the first section of the webpage 104, and so the document object 212 and the document object 214 can have or specify as textual content whatever words, phrases, sentences, or sentence fragments make up those two paragraphs. As another non-limiting example, the document object 216 can be a paragraph of the second section of the webpage 104, and so the document object 216 can have or specify as textual content whatever words, phrases, sentences, or sentence fragments make up that paragraph.

Referring back to FIG. 1, the webpage 104 can correspond to or otherwise be associated with the webpage-based application 108. In various embodiments, the webpage-based application 108 can be any suitable computer software program that can automatically interact with a client who visits the webpage 104. More specifically, the webpage-based application 108 can be configured or otherwise programmed to provide to the client one or more of a set of outputs 110, where each of the set of outputs 110 can be an electronic response to a possible, potential, or foreseen condition or circumstance pertaining to the client. In various aspects, each of the set of outputs 110 can be based on at least some textual content that is exhibited by the webpage 104.

As shown in FIG. 2, the set of outputs 110 can, in various aspects, comprise n outputs for any suitable positive integer n: an output 110(1) to an output 110(n). In various aspects, each of the set of outputs 110 can be any suitable electronic data exhibiting any suitable size, format, or dimensionality. In various instances, the size, format, or dimensionality of each of the set of outputs 110 can depend upon whatever function the webpage-based application 108 is configured to perform with respect to the webpage 104. As a non-limiting example, the webpage-based application 108 can be a chatbot associated with the webpage 104. In such case, each of the set of outputs 110 can be a textual answer that is based on respective text written in the webpage 104 and which the chatbot can provide to the client in response to one or more textual queries asked by the client.

Referring back to FIG. 1, a technician or software engineer that is overseeing the webpage 104 can, from time to time, perform edits on the webpage 104. Because the set of outputs 110 can be based on the textual content of the webpage 104, an edit made to the textual content of the webpage 104 can, in some cases, render one or more of the set of outputs 110 obsolete or inaccurate (e.g., the edit can be made to portions of text that were relied upon to generate, formulate, or justify the set of outputs 110). In such cases, it can be warranted for the technician or software engineer to make a commensurate edit to the webpage-based application 108. However, in other cases, an edit made to the textual content of the webpage 104 can be irrelevant to the set of outputs 110 (e.g., the edit can be made to portions of text that were not relied upon to generate, formulate, or justify the set of outputs 110). In such cases, it can be unwarranted for the technician or software engineer to make a commensurate edit to the webpage-based application 108.

Thus, whenever an edit is performed on the webpage 104, it can be desired to determine whether or not a commensurate edit should be made on the webpage-based application 108. In various instances, as described herein, the edit management system 102 can automatically facilitate such determination.

In various embodiments, the edit management system 102 can comprise a processor 112 (e.g., computer processing unit, microprocessor) and a non-transitory computer-readable memory 114 that is operably connected or coupled to the processor 112. The memory 114 can store computer-executable instructions which, upon execution by the processor 112, can cause the processor 112 or other components of the edit management system 102 (e.g., detection component 116, consistency component 118, alert component 120) to perform one or more acts. In various embodiments, the memory 114 can store computer-executable components (e.g., detection component 116, consistency component 118, alert component 120), and the processor 112 can execute the computer-executable components.

In various embodiments, the edit management system 102 can comprise a detection component 116. In various aspects, as described herein, the detection component 116 can detect when an edit is made to the webpage 104.

In various embodiments, the edit management system 102 can comprise a consistency component 118. In various instances, as described herein, the consistency component 118 can determine whether or not the webpage-based application 108 is consistent with the edit, based on a text-context registry.

In various embodiments, the edit management system 102 can comprise an alert component 120. In various cases, as described herein, the alert component 120 can generate an electronic alert based on one or more determinations of the consistency component 118.

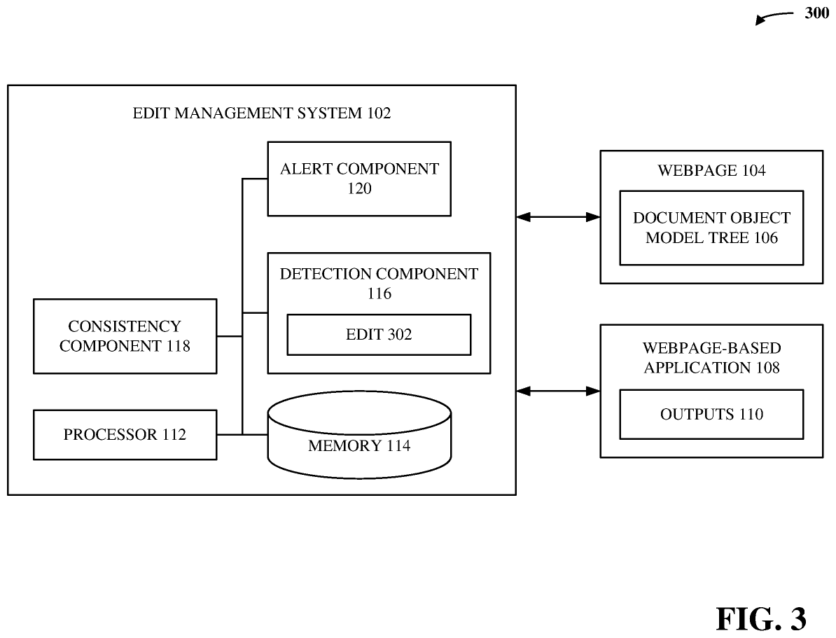

FIG. 3 illustrates a block diagram of an example, non-limiting system 300 including an edit that can facilitate context-aware edit management of webpage-based applications in accordance with one or more embodiments described herein. As shown, the system 300 can, in some cases, comprise the same components as the system 100, and can further comprise an edit 302.

In various embodiments, the edit 302 can be any suitable textual or coding edit that can be made by a technician or software engineer to the DOM tree 106 and thus to the webpage 104. In various aspects, the detection component 116 can electronically detect the edit 302. More specifically, the detection component 116 can electronically access, such as via an Internet connection, the webpage 104. Accordingly, the detection component 116 can electronically monitor the webpage 104 in search of edits. In various instances, the detection component 116 can perform such monitoring on any suitable temporal basis. As a non-limiting example, the detection component 116 can continuously or continually monitor the webpage 104 for edits. As another non-limiting example, the detection component 116 can periodically monitor the webpage 104 for edits, according to any suitable monitoring interval or period. As yet another non-limiting example, the detection component 116 can aperiodically (e.g., in an ad hoc fashion) monitor the webpage 104 for edits. In various cases, the detection component 116 can leverage any suitable edit detection techniques to facilitate such monitoring. As a non-limiting example, the detection component 116 can utilize a Delta technique based on fuzzy tree differences in order to detect edits made to the webpage 104. As another non-limiting example, the detection component 116 can utilize an HTML digest comparison algorithm to detect edits made to the webpage 104.

In any case, it can be possible for a technician or software engineer to make the edit 302 to the webpage 104, and the detection component 116 can detect or otherwise determine that the edit 302 has occurred.

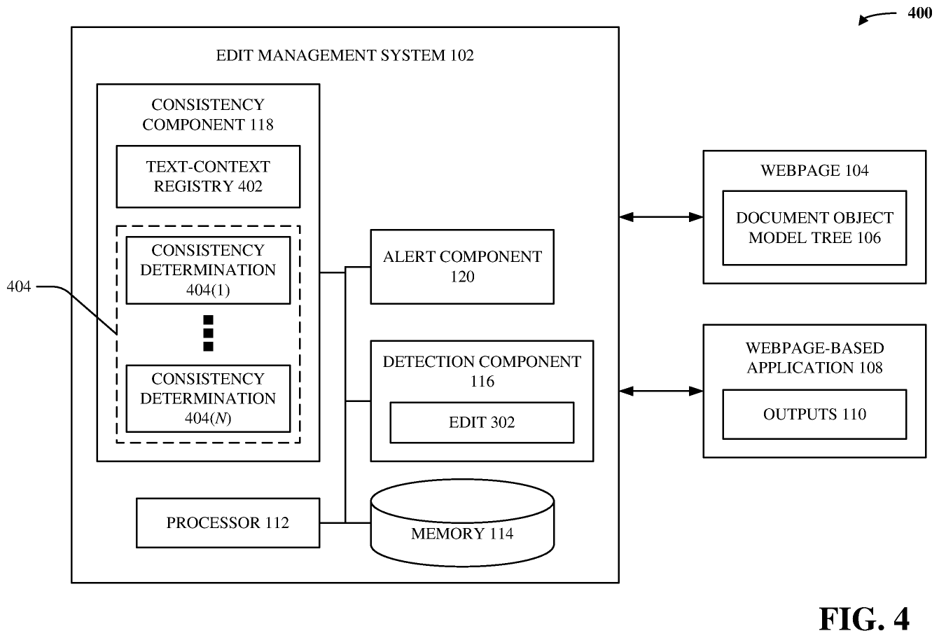

FIG. 4 illustrates a block diagram of an example, non-limiting system 400 including a text-context registry and a set of consistency determinations that can facilitate context-aware edit management of webpage-based applications in accordance with one or more embodiments described herein. As shown, the system 400 can, in some cases, comprise the same components as the system 300, and can further comprise a text-context registry 402 and a set of consistency determinations 404.

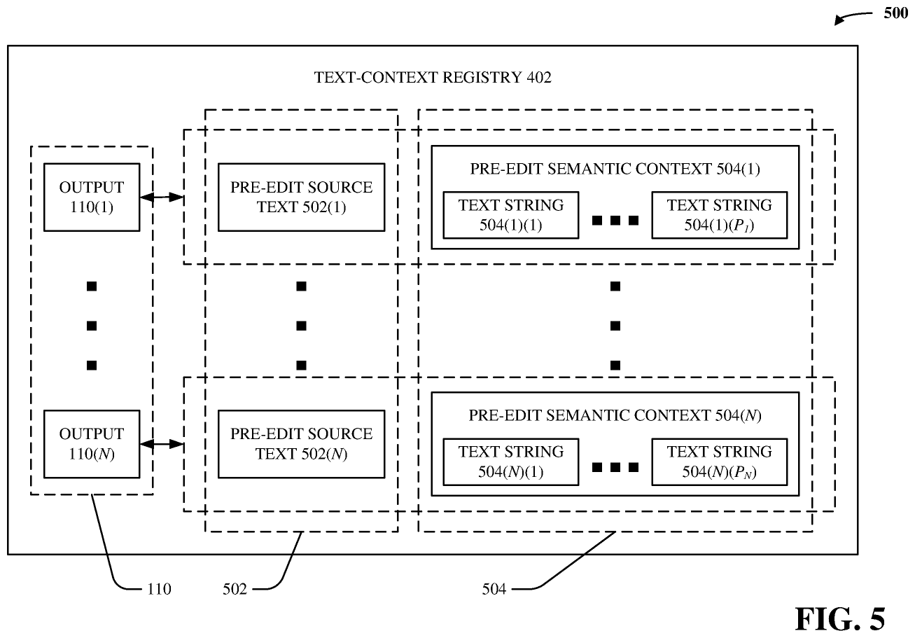

In various embodiments, the consistency component 118 can electronically store, maintain, control, or otherwise access the text-context registry 402. In various cases, the text-context registry 402 can be any suitable electronic data structure that respectively links, maps, or correlates the set of outputs 110 with pre-edit source texts and with corresponding pre-edit semantic contexts. In various instances, the consistency component 118 can utilize such pre-edit source texts and such pre-edit semantic contexts to determine whether each of the set of outputs 110 is consistent with the edit 302. Various non-limiting aspects are further described with respect to FIG. 5.

FIG. 5 illustrates an example, non-limiting block diagram 500 of the text-context registry 402 in accordance with one or more embodiments described herein.

As shown, the text-context registry 402 can comprise the set of outputs 110. As also shown, the text-context registry 402 can comprise a set of pre-edit source texts 502. In various aspects, the set of pre-edit source texts 502 can respectively correspond (e.g., in one-to-one fashion) to the set of outputs 110. Accordingly, since the set of outputs 110 can comprise n outputs, the set of pre-edit source texts 502 can likewise comprise n source texts: a pre-edit source text 502(1) to a pre-edit source text 502(n). In various instances, each of the set of pre-edit source texts 502 can be any suitable textual content that was present within the webpage 104 prior to performance of the edit 302 (hence the term “pre-edit”) and from which a respective one of the set of outputs 110 was sourced, derived, or otherwise based. As a non-limiting example, the output 110(1) can correspond to the pre-edit source text 502(1). Thus, the pre-edit source text 502(1) can be any suitable words, phrases, sentences, or sentence fragments that were written somewhere within the webpage 104 before the edit 302 occurred, and such words, phrases, sentences, or sentence fragments can have justified, demonstrated the correctness of, or otherwise served as a substantive basis for the output 110(1). As another non-limiting example, the output 110(n) can correspond to the pre-edit source text 502(n). So, the pre-edit source text 502(n) can be any suitable words, phrases, sentences, or sentence fragments that were written somewhere within the webpage 104 before the edit 302 occurred, and such words, phrases, sentences, or sentence fragments can have justified, demonstrated the correctness of, or otherwise served as a substantive basis for the output 110(n).

As also shown, the text-context registry 402 can comprise a set of pre-edit semantic contexts 504. In various aspects, the set of pre-edit semantic contexts 504 can respectively correspond (e.g., in one-to-one fashion) to the set of pre-edit source texts 502. Accordingly, since the set of pre-edit source texts 502 can comprise n source texts, the set of pre-edit semantic contexts 504 can likewise comprise n semantic contexts: a pre-edit semantic context 504(1) to a pre-edit semantic context 504(n). In various instances, each of the set of pre-edit semantic contexts 504 can be any suitable chain of text strings that were present within the webpage 104 prior to performance of the edit 302 (hence the term “pre-edit”) and that come from the textual contents of whichever DOM objects a respective one of the set of pre-edit source texts 502 was nested within.

As a non-limiting example, the pre-edit semantic context 504(1) can correspond to the pre-edit source text 502(1). Accordingly, the pre-edit semantic context 504(1) can be a chain of text strings, where such text strings can be based on the textual contents of whichever document objects the pre-edit source text 502(1) is nested within. For instance, the pre-edit source text 502(1) can have been nested within a total of p₁ document objects, for any suitable positive integer p₁. That is, prior to performance of the edit 302, there can have been a first document object (e.g., 202) within the DOM tree 106, there can have been a second document object (e.g., 206) nested under the first document object, there can have been a third document object (e.g., 208) nested under the second document object, and such nesting pattern can culminate in a p₁-th document object within which the pre-edit source text 502(1) can have been nested. Thus, the pre-edit semantic context 504(1) can comprise a text string 504(1)(1) which can come from or be based on whatever textual content (if any) was written within that first document object, the pre-edit semantic context 504(1) can comprise a text string 504(1)(2) (not shown) which can come from or be based on whatever textual content (if any) was written within that second document object, the pre-edit semantic context 504(1) can comprise a text string 504(1)(3) (not shown) which can come from or be based on whatever textual content (if any) was written within that third document, and, continuing in such fashion, the pre-edit semantic context 504(1) can comprise a text string 504(1)(p₁) which can come from or be based on whatever textual content (if any) was written within that p₁-th document object.

In some instances, each text string of the pre-edit semantic context 504(1) can be a title or header of a respective document object (e.g., the text string 504(1)(1) can be a title or header of the first document object under which the pre-edit source text 502(1) was nested, the text string 504(1)(p₁) can be a title or header of the p₁-th document object under which the pre-edit source text 502(1) was nested).

In other instances, each text string of the pre-edit semantic context 504(1) can be a summary of textual content of a respective document object (e.g., the text string 504(1)(1) can be a summary of the textual content of the first document object under which the pre-edit source text 502(1) was nested, the text string 504(1)(p₁) can be a summary of the textual content of the p₁-th document object under which the pre-edit source text 502(1) was nested).

In yet other instances, each text string of the pre-edit semantic context 504(1) can be a full or partial copy of textual content of a respective document object (e.g., the text string 504(1)(1) can be a full or partial copy of the textual content of the first document object under which the pre-edit source text 502(1) was nested, the text string 504(1)(p₁) can be a full or partial copy of the textual content of the p₁-th document object under which the pre-edit source text 502(1) was nested).

In still other instances, some document objects under which the pre-edit source text 502(1) was nested can be ignored or omitted for semantic context purposes. In other words, there can be some document objects whose titles/headers are not present within the pre-edit semantic context 504(1), whose textual contents are not summarized in the pre-edit semantic context 504(1), and whose textual contents are not fully or partially copied into the pre-edit semantic context 504(1). Note that, in such cases, the pre-edit source text 502(1) can be considered as having been nested within more than p₁ document objects.

In even other instances, any suitable combination of the aforementioned can be implemented. As an example, some text strings of the pre-edit semantic context 504(1) can be titles or headers of respective document objects, while other text strings of the pre-edit semantic context 504(1) can be summaries of the textual contents of respective document objects, while still other text strings of the pre-edit semantic context 504(1) can be full or partial copies of the textual contents of respective document objects. In other words, different document objects can be treated the same or differently as each other for semantic context purposes (e.g., titles or headers can be taken from some document objects, whereas summaries of textual content can be taken from other document objects, whereas full or partial copies of textual content can be taken from yet other document objects, whereas the textual content of still other document objects can be omitted or ignored). In some aspects, such differential treatment can be based on DOM tags (e.g., document objects having a particular type of DOM tag can be ignored for semantic context purposes) or can be based on textual content length (e.g., summaries, titles/headers, or partial copies of textual content can be implemented for non-ignored document objects whose textual contents are longer than a threshold length, whereas full copies of textual content can be implemented for non-ignored document objects whose textual contents are shorter than the threshold length).

As another non-limiting example, the pre-edit semantic context 504(n) can correspond to the pre-edit source text 502(n). So, the pre-edit semantic context 504(n) can be a chain of text strings, where such text strings can be based on the textual contents of whichever document objects the pre-edit source text 502(n) is nested within. As shown, the pre-edit semantic context 502(n) can comprise a total of pₙ text strings, for any suitable positive integer pₙ: a text string 504(n)(1) to a text string 504(n)(pₙ).

In some aspects, just as explained above, the pre-edit source text 502(n) can have been nested within a total of pₙ document objects, and each of the pₙ text strings can be based on the textual content of a respective one of those pₙ document objects (e.g., the text string 504(n)(1) can be based on textual content of a first document object under which the pre-edit source text 502(n) is nested; the text string 504(n)(pₙ) can be based on textual content of a pₙ-th document object under which the pre-edit source text 502(n) is nested). In other aspects, also as explained above, the pre-edit source text 502(n) can have been nested within more than pₙ document objects, and the textual contents of some of those document objects can have been ignored or omitted for semantic context purposes.

Furthermore, just as explained above, the text strings of the pre-edit semantic context 504(n) can based, in any suitable fashion, on the textual contents of document objects under which the pre-edit source text 502(n) is nested. As a non-limiting example, any text string of the pre-edit semantic context 504(n) can be a title or header of a respective document object under which the pre-edit source text 502(n) is nested. As another non-limiting example, any text string of the pre-edit semantic context 504(n) can be a summary of whatever textual content is written in a respective document object under which the pre-edit source text 502(n) is nested. As yet another non-limiting example, any text string of the pre-edit semantic context 504(n) can be a full or partial copy of whatever textual content is written in a respective document object under which the pre-edit source text 502(n) is nested. Moreover, just as described above, any suitable combination of these fashions can be implemented, such that different document objects can be treated the same or differently as each other for semantic context purposes (e.g., titles or headers can be taken from some document objects, whereas summaries of textual content can be taken from other document objects, whereas full or partial copies of textual content can be taken from yet other document objects, whereas the textual contents of still other document objects can be omitted or ignored). As mentioned above, such differential treatment can be based on document object type/tag or on textual content length.

For further clarity or explanation, consider again the non-limiting, example embodiment of the DOM tree 106 shown in FIG. 2. Suppose that a given pre-edit source text is written within the document object 212. In such case, a pre-edit semantic context of that given pre-edit source text can be a chain of three text strings, since the document object 212 is nested within three document objects. Indeed, backwards traversal of the DOM tree 106 shows that the document object 212 is nested within the document object 208, which is nested within the document object 206, which is nested within the document object 202. Accordingly, in a non-limiting example, a first text string of that pre-edit semantic context can come from or otherwise be based on whatever textual content (if any) is written within the document object 202 (e.g., the first text string can be a title or header of the document object 202), a second text string of that pre-edit semantic context can come from or otherwise be based on whatever textual content (if any) is written within the document object 206 (e.g., the second text string can be a title or header of the document object 206), and a third text string of that pre-edit semantic context can come from or otherwise be based on whatever textual content (if any) is written within the document object 208 (e.g., the third text string can be a title or header of the document object 208).

As another example, suppose that a given pre-edit source text is written within the document object 210. In such case, a pre-edit semantic context of that given pre-edit source text can be a chain of two text strings, since the document object 210 is nested within two document objects. Indeed, backwards traversal of the DOM tree 106 shows that the document object 210 is nested within the document object 206, which is nested within the document object 202. Accordingly, in a non-limiting example, a first text string of that pre-edit semantic context can come from or otherwise be based on whatever textual content (if any) is written within the document object 202 (e.g., the first text string can be a title or header of the document object 202), and a second text string of that pre-edit semantic context can come from or otherwise be based on whatever textual content (if any) is written within the document object 206 (e.g., the second text string can be a title or header of the document object 206).

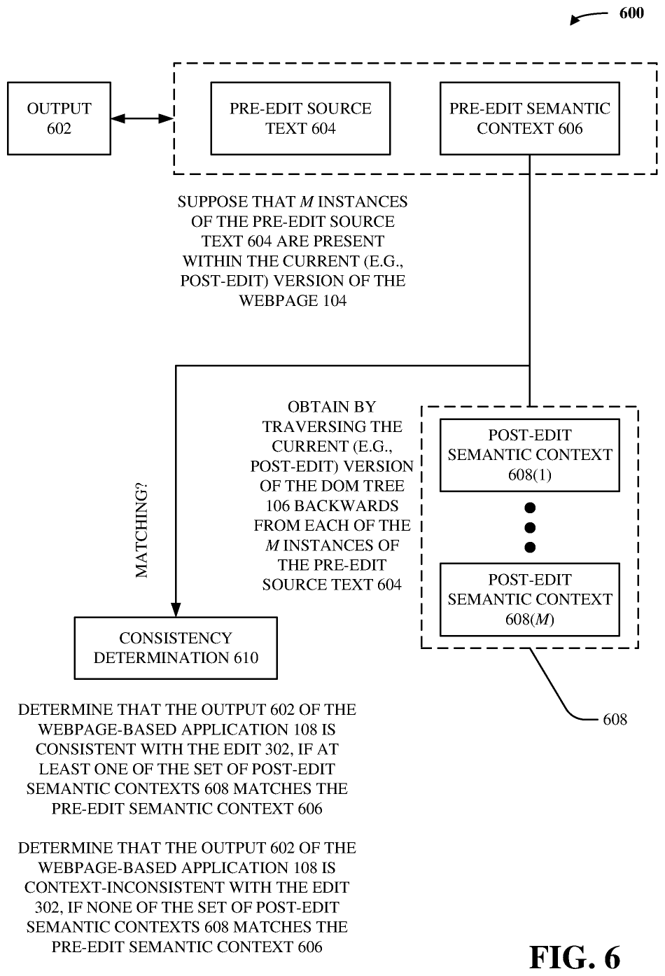

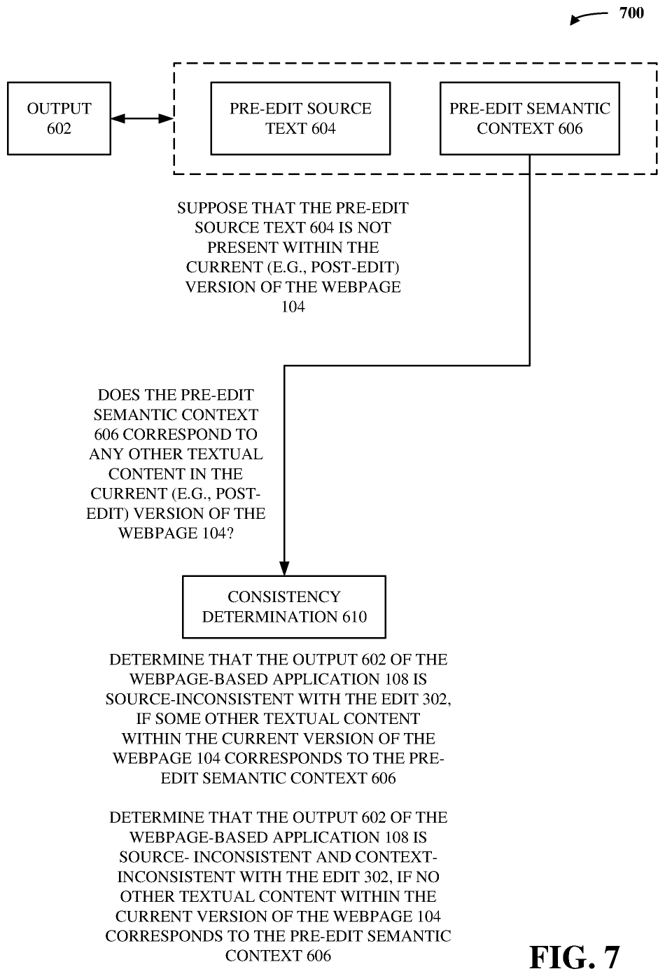

Referring back to FIGS. 4 and 5, the consistency component 118 can generate the set of consistency determinations 404, by leveraging the text-context registry 402. In particular, the consistency component 118 can, in various aspects, iterate through each of the set of outputs 110. For any given output in the set of outputs 110, the consistency component 118 can generate a respective consistency determination, based on the pre-edit source text and the pre-edit semantic context that correspond to that given output. As a non-limiting example, the consistency component 118 can generate a consistency determination 404(1), based on the pre-edit source text 502(1) and based on the pre-edit semantic context 504(1), where the consistency determination 404(1) can be any suitable electronic data indicating whether the output 110(1) is consistent with the edit 302. As another non-limiting example, the consistency component 118 can generate a consistency determination 404(n), based on the pre-edit source text 502(n) and based on the pre-edit semantic context 504(n), where the consistency determination 404(n) can be any suitable electronic data indicating whether the output 110(n) is consistent with the edit 302. In various cases, the consistency determination 404(1) to the consistency determination 404(n) can collectively be considered as the set of consistency determinations 404. Various non-limiting aspects are described with respect to FIGS. 6-7.

FIGS. 6-7 illustrate example, non-limiting block diagrams 600 and 700 showing how the text-context registry 402 can be leveraged to determine whether or not an output (e.g., one of 110) of the webpage-based application 108 is consistent with the edit 302 of the webpage 104 in accordance with one or more embodiments described herein.

First, consider FIG. 6. In various aspects, the consistency component 118 can select, consider, or otherwise iterate to any of the set of outputs 110. Such selected output can be referred to as an output 602. In various instances, the consistency component 118 can identify, within the text-context registry 402, whichever pre-edit source text (e.g., one of 502) and whichever pre-edit semantic context (e.g., one of 504) correspond to the output 602. Such identified pre-edit source text can be referred to as a pre-edit source text 604, and such identified pre-edit semantic context can be referred to as a pre-edit semantic context 606.

In various cases, after performance or detection of the edit 302, the consistency component 118 can search, via any suitable text matching or semantic similarity comparison technique, the webpage 104 for the pre-edit source text 604. In other words, the consistency component 118 can parse or scour a current or post-edit version of the webpage 104 for the pre-edit source text 604.

As shown in FIG. 6, it can be the case that the consistency component 118 finds or locates m instances (e.g., m copies or repetitions) of the pre-edit source text 604 within the current or post-edit version of the webpage 104, for any suitable positive integer m. That is, the pre-edit source text 604 can be written within the current or post-edit version of the webpage 104 in m distinct locations. In various aspects, the consistency component 118 can generate a respective post-edit semantic context for each of such m instances of the pre-edit source text 604, thereby yielding a set of post-edit semantic contexts 608. More specifically, the consistency component 118 can locate any one of the m instances of the pre-edit source text 604 within the current or post-edit version of the DOM tree 106, and the consistency component 118 can generate a semantic context for that instance of the pre-edit source text 604 by traversing the current or post-edit version of the DOM tree 106 backwards from that instance of the pre-edit source text 604, just as described above. As a non-limiting example, the consistency component 118 can locate a first instance of the pre-edit source text 604 within the current or post-edit version of the DOM tree 106, and the consistency component 118 can generate a post-edit semantic context 608(1) by backwards-traversing the current or post-edit version of the DOM tree 106 from that first instance of the pre-edit source text 604 (e.g., the post-edit semantic context 608(1) can be a chain of text strings, with each text string being based on the textual content of a respective document object under which that first instance of the pre-edit source text 604 is currently nested). As another non-limiting example, the consistency component 118 can locate an m-th instance of the pre-edit source text 604 within the current or post-edit version of the DOM tree 106, and the consistency component 118 can generate a post-edit semantic context 608(m) by backwards-traversing the current or post-edit version of the DOM tree 106 from that m-th instance of the pre-edit source text 604 (e.g., the post-edit semantic context 608(m) can be a chain of text strings, with each text string being based on the textual content of a respective document object under which that m-th instance of the pre-edit source text 604 is currently nested). In various cases, the post-edit semantic context 608(1) to the post-edit semantic context 608(m) can collectively be referred to as the set of post-edit semantic contexts 608. Because such semantic contexts can be created after performance or detection of the edit 302, the term “post-edit” can be appropriate.

In various aspects, the consistency component 118 can compare, via text matching or semantic similarity comparison, the pre-edit semantic context 606 with each of the set of post-edit semantic contexts 608, and the consistency component 118 can generate a consistency determination (e.g., one of 404) for the output 602 based on such comparison. In various instances, such generated consistency determination can be referred to as a consistency determination 610. In some aspects, it can be possible that at least one of the set of post-edit semantic contexts 608 matches (e.g., is the same as, or is otherwise within any suitable threshold margin of similarity of) the pre-edit semantic context 606. In such case, the consistency determination 610 can indicate that the output 602 is consistent with the edit 302 (e.g., can indicate that the pre-edit source text 604 has been found to have the pre-edit semantic context 606 within the current or post-edit version of the webpage 104). On the other hand, it can instead be possible that none of the set of post-edit semantic contexts 608 matches (e.g., is the same as, or is otherwise within any suitable threshold margin of similarity of) the pre-edit semantic context 606. In such case, the consistency determination 610 can indicate that the output 602 is inconsistent with the edit 302. More specifically, in such case, the consistency determination 610 can indicate that the output 602 is context-inconsistent with the edit 302 (e.g., can indicate that the pre-edit source text 604 has been found to have a different semantic context within the current or post-edit version of the webpage 104).

Now, consider FIG. 7. As shown, it can be the case that the consistency component 118 finds or locates no instances (e.g., no copies) of the pre-edit source text 604 within the current or post-edit version of the webpage 104. That is, the pre-edit source text 604 can be no longer written anywhere within the current or post-edit version of the webpage 104.

In various instances, in response to determining that the pre-edit source text 604 is not present in the current or post-edit version of the webpage 104, the consistency component 118 can search the current or post-edit version of the webpage 104 for any textual content whose semantic context matches (e.g., is the same as, or is otherwise within any suitable threshold margin of similarity of) the pre-edit semantic context 606. In some cases, it can be possible that at least some textual content within the current or post-edit version of the webpage 104 has a semantic context that matches the pre-edit semantic context 606. In such case, the consistency determination 610 can indicate that the output 602 is inconsistent with the edit 302. More specifically, in such case, the consistency determination 610 can indicate that the output 602 is source-inconsistent with the edit 302 (e.g., can indicate that the pre-edit semantic context 606 has been found to have a different source text within the current or post-edit version of the webpage 104). On the other hand, it can be possible that no textual content within the current or post-edit version of the webpage 104 has a semantic context that matches the pre-edit semantic context 606. In such case, the consistency determination 610 can indicate that the output 602 is inconsistent with the edit 302. More specifically, in such case, the consistency determination 610 can indicate that the output 602 is both source-inconsistent and context-inconsistent with the edit 302 (e.g., can indicate that neither the pre-edit source text 604 nor the pre-edit semantic context 606 were found within the current or post-edit version of the webpage 104).

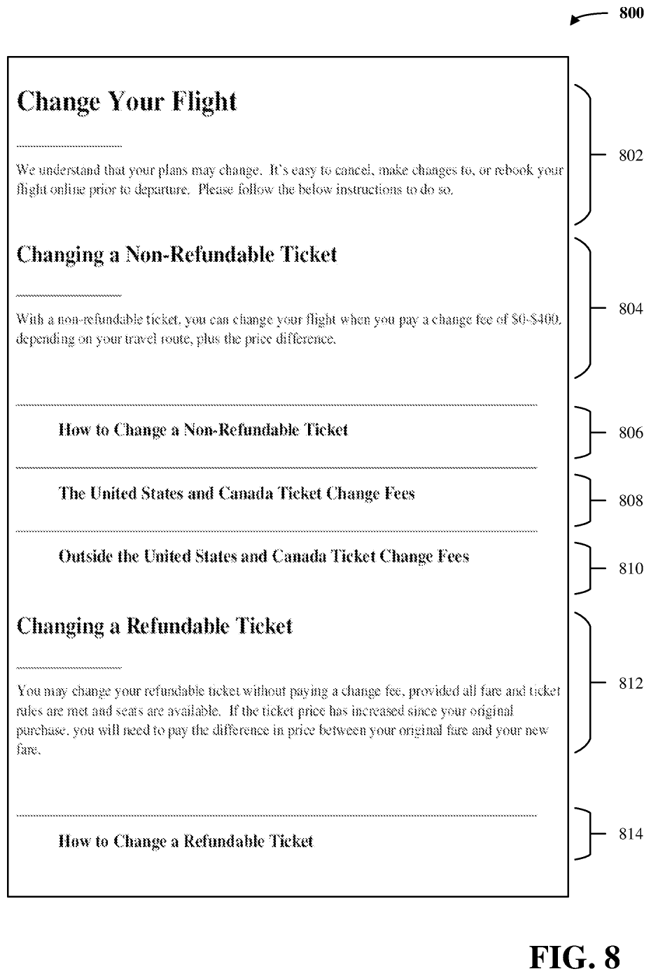

To provide further clarification or explanation, consider FIGS. 8-11. FIGS. 8-11 illustrate, in example, non-limiting fashion, how various aspects can be applied to real-world webpages in accordance with one or more embodiments described herein.

First, consider FIG. 8. As shown, there can be a webpage 800 that can pertain to instructions for changing an airline ticket. In various aspects, the webpage 800 can comprise a document object 802 which can comprise various textual content. In particular, the document object 802 can include a title (“Change Your Flight”) of the webpage 800 and can include a paragraph or block of text (“We understand that your plans may change . . . ”) that is pertinent to an entirety of the webpage 800. In various instances, there can be a document object 804 and a document object 812 that are nested within or beneath the document object 802, each of which can comprise various textual content. Specifically, the document object 804 can demarcate a first section of the webpage 800, where such first section can have a title (“Changing a Non-Refundable Ticket”), and where such first section can include a paragraph or block of text that is pertinent to such first section (“With a non-refundable ticket, you can . . . ”). Similarly, the document object 812 can demarcate a second section of the webpage 800, where such second section can have a title (“Changing a Refundable Ticket”), and where such second section can include a paragraph or block of text that is pertinent to such second section (“You may change your refundable ticket . . . ”). In various cases, there can be a document object 806, a document object 808, and a document object 810 that are nested within or beneath the document object 804, each of which can comprise various textual content. In particular, the document object 806 can be a first drop-down menu within the first section of the webpage 800, and such first drop-down menu can have a title (“How to Change a Non-Refundable Ticket”). Similarly, the document object 808 can be a second drop-down menu within the first section of the webpage 800, and such second drop-down menu can have a title (“The United States and Canada Ticket Change Fees”). Likewise, the document object 810 can be a third drop-down menu within the first section of the webpage 800, and such third drop-down menu can have a title (“Outside the United States and Canada Ticket Change Fees”). In various aspects, there can be a document object 814 that is nested within or beneath the document object 812, which can comprise various textual content. For instance, the document object 814 can be a drop-down menu within the second section of the webpage 800, and such drop-down menu can have a title (“How to Change a Refundable Ticket”).

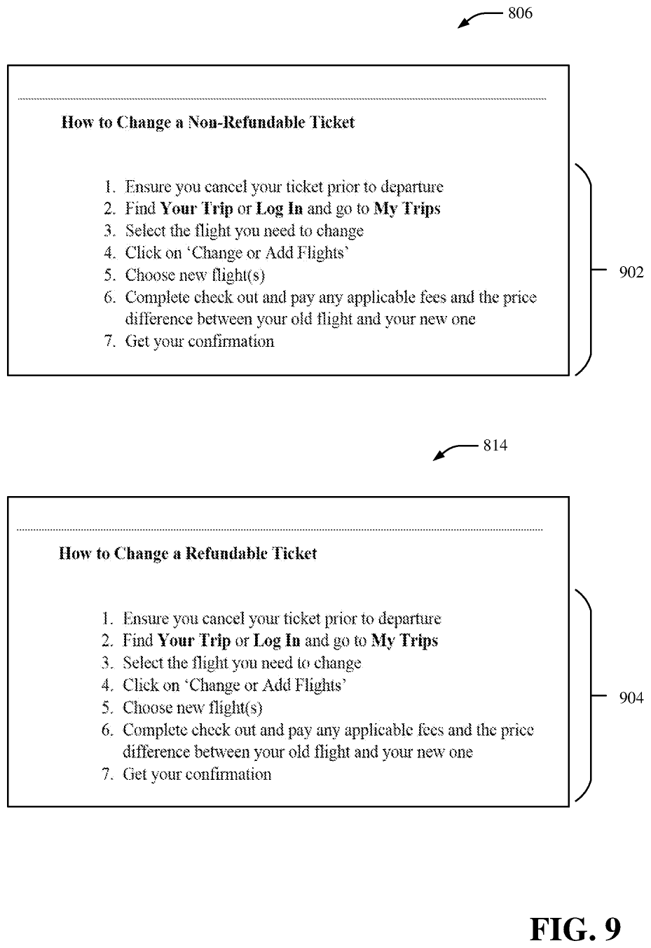

Now, consider FIG. 9. As shown, there can be a document object 902 nested within or beneath the document object 806. In particular, the document object 902 can be an ordered list that recites the steps one can follow to change a non-refundable ticket. As also shown, there can be a document object 904 nested within or beneath the document object 814. Specifically, the document object 904 can be an ordered list that recites the steps one can follow to change a refundable ticket.

As shown, it can be the case that the object 902 and the document object 904 have the same textual content as each other. In other words, such textual content is repeated in the webpage 800.

However, such repeated textual content can have different semantic contexts. In particular, because the document object 902 is nested within the document object 806, which is nested within the document object 804, which is nested within the document object 802, the document object 902 can have as a semantic context a chain of three text strings: one text string based on the textual content of the document object 802, another text string based on the textual content of the document object 804, and yet another text string based on the textual content of the document object 806. As a non-limiting example, such semantic context can be the following chain of titles: [“Change Your Flight”; “Changing a Non-Refundable Ticket”; “How to Change a Non-Refundable Ticket”]. In contrast, because the document object 904 is nested within the document object 814, which is nested within the document object 812, which is nested within the document object 802, the document object 904 can have as a semantic context a different chain of three text strings: one text string based on the textual content of the document object 802, another text string based on the textual content of the document object 812, and yet another text string based on the textual content of the document object 814. As a non-limiting example, such semantic context can be the following chain of titles: [“Change Your Flight”; “Changing a Refundable Ticket”; “How to Change a Refundable Ticket”].

As mentioned above, techniques that rely solely upon text matching can fail in situations where textual content is repeated throughout a webpage, such as shown in FIG. 9. After all, if an edit is made to one instance of such repeated textual content (e.g., if an edit is made to the textual content of the document object 902), text matching alone would be unable to detect such edit due to the presence of the other instances of such repeated textual content (e.g., due to the presence of the textual content of the document object 904). However, because the document object 902 and the document object 904 have different semantic contexts, various embodiments described herein can avoid such missed detection.

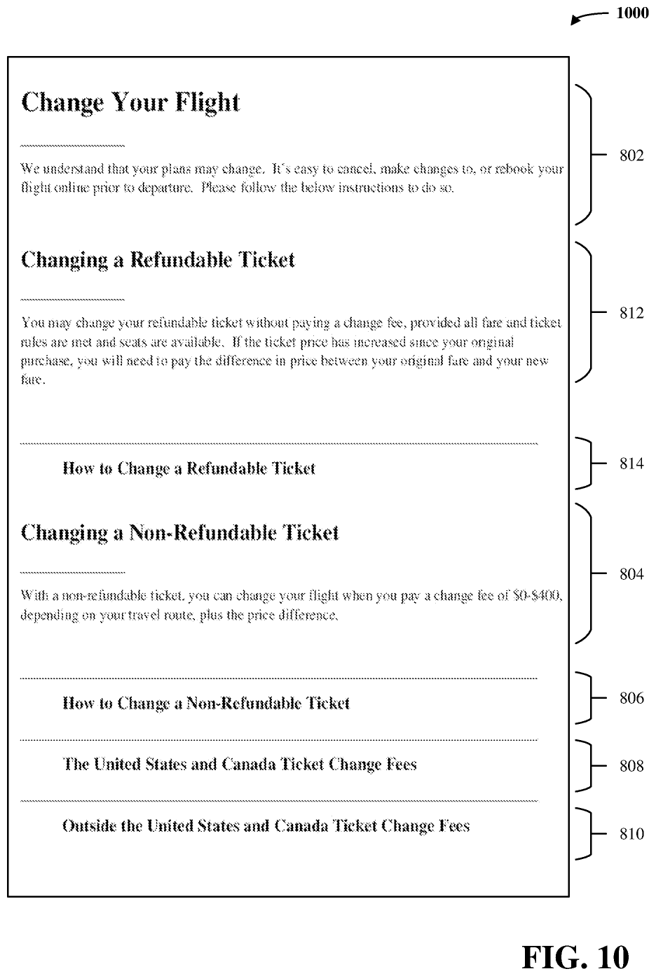

Now, consider FIG. 10, which illustrates a webpage 1000. As shown, the textual content of the webpage 1000 is identical to that of the webpage 800. However, the nesting order of the document objects has changed. In particular, the document object 812 is listed after the document object 804 in the webpage 800, but the document object 812 is listed before the document object 804 in the webpage 1000. Such change in ordering alters the Xpaths of the document object 902 and of the document object 904. However, such change in ordering does not alter the semantic contexts of the document object 902 and of the document object 904 (e.g., since the textual contents of the document objects 804, 806, 812, and 814 can remain unchanged). In other words, the semantic context of the document object 902 would still be [“Change Your Flight”; “Changing a Non-Refundable Ticket”; “How to Change a Non-Refundable Ticket”] in the webpage 1000, and the semantic context of the document object 904 would still be [“Change Your Flight”; “Changing a Refundable Ticket”; “How to Change a Refundable Ticket”] in the webpage 1000. So, if an edit were made to convert the webpage 800 to the webpage 1000, existing techniques that rely upon Xpath comparison would raise a false alarm, whereas various embodiments described herein would not raise such a false alarm.

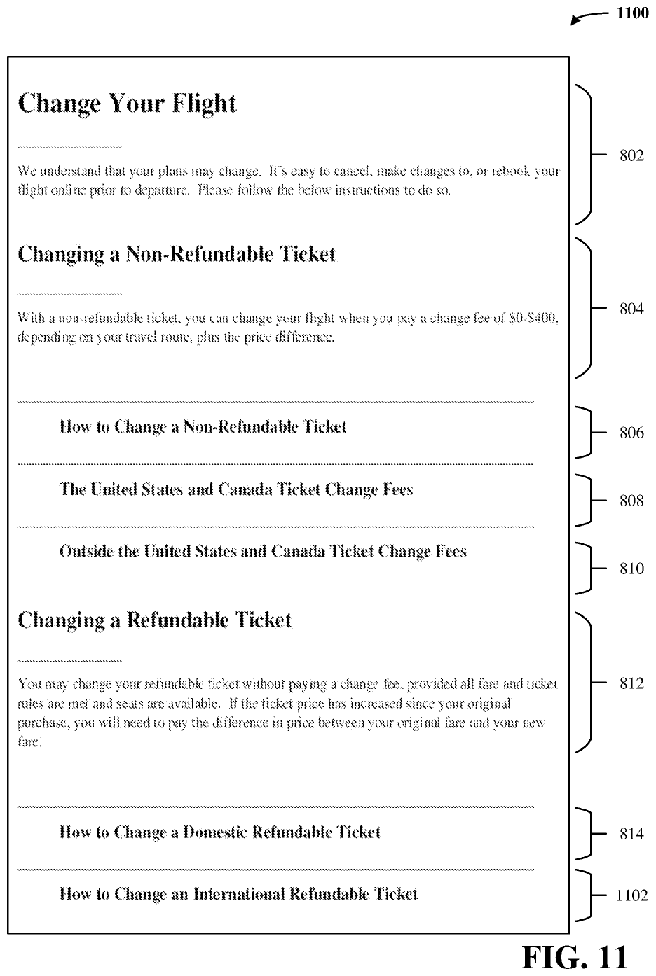

Now, consider FIG. 11, which illustrates a webpage 1100. As shown, the webpage 1100 can have the document objects 802, 804, 806, 808, 810, 812, and 814, as described above. However, as shown, the document object 814 can have a different title in the webpage 1100 (“How to Change a Domestic Refundable Ticket” instead of “How to Change a Refundable Ticket”). Also as shown, a new document object 1102 can be nested within or beneath the document object 812, where the new document object 1102 can be a second drop-down menu having a title (“How to Change an International Refundable Ticket”). Note that changing the title of the document object 814 can change the semantic context of the document object 904, without changing its Xpath. In other words, the semantic context of the textual content of the document object 904 would no longer be [“Change Your Flight”; “Changing a Refundable Ticket”; “How to Change a Refundable Ticket”] in the webpage 1100. Instead, it would be [“Change Your Flight”; “Changing a Refundable Ticket”; “How to Change a Domestic Refundable Ticket”]). So, if an edit were made to convert the webpage 800 to the webpage 1100, existing techniques that rely upon Xpath comparison would fail to raise an alarm, whereas various embodiments described herein would not suffer such failure.

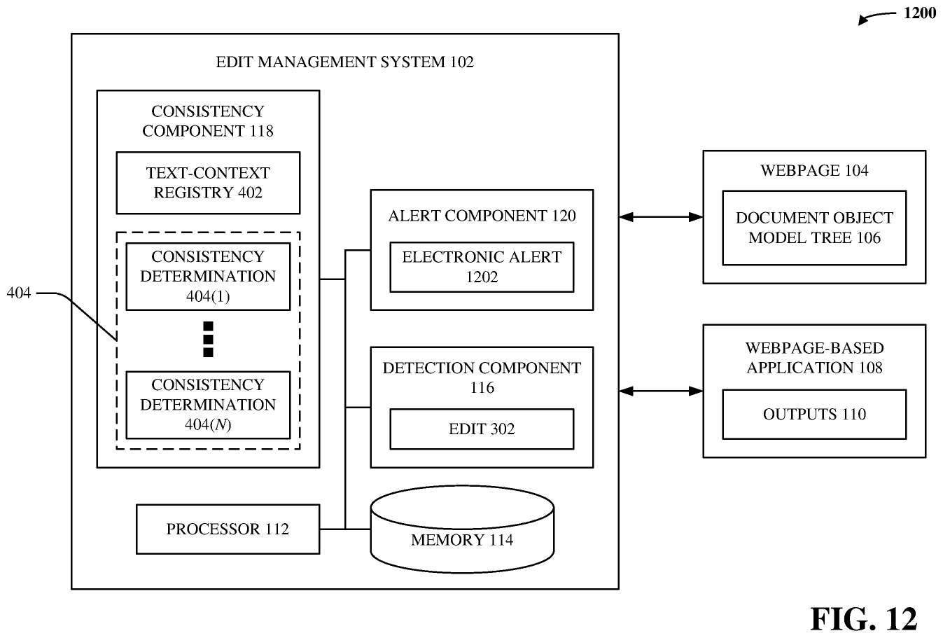

FIG. 12 illustrates a block diagram of an example, non-limiting system 1200 including an electronic alert that can facilitate context-aware edit management of webpage-based applications in accordance with one or more embodiments described herein. As shown, the system 1200 can, in some cases, comprise the same components as the system 400, and can further comprise an electronic alert 1202.

In various embodiments, the alert component 120 can electronically generate the electronic alert 1202, based on the set of consistency determinations 404. In particular, the electronic alert 1202 can be any suitable electronic message or warning that can textually, visually, or audibly convey or indicate any of the set of consistency determinations 404. As a non-limiting example, the electronic alert 1202 can, in some aspects, indicate or convey which (if any) of the set of outputs 110 have been determined to be consistent with the edit 302. As another non-limiting example, the electronic alert 1202 can, in some instances, indicate or convey which (if any) of the set of outputs 110 have been determined to be source-inconsistent with the edit 302. As still another non-limiting example, the electronic alert 1202 can, in some cases, indicate or convey which (if any) of the set of outputs 110 have been determined to be context-inconsistent with the edit 302. As yet another non-limiting example, the electronic alert 1202 can, in some instances, indicate or convey which (if any) of the set of outputs 110 have been determined to be both source-inconsistent and context-inconsistent with the edit 302. In various aspects, the alert component 120 can render the electronic alert 1202 on any suitable electronic display (e.g., computer screen, computer monitor). In various other aspects, the alert component 120 can transmit the electronic alert 1202 to any other suitable computing device. In any case, a technician or software engineer who is tasked with overseeing or maintaining the webpage 104 or the webpage-based application 108 can view or read the electronic alert 1202, so as to become aware of which (if any) of the set of outputs 110 should be edited commensurately with the edit 302.

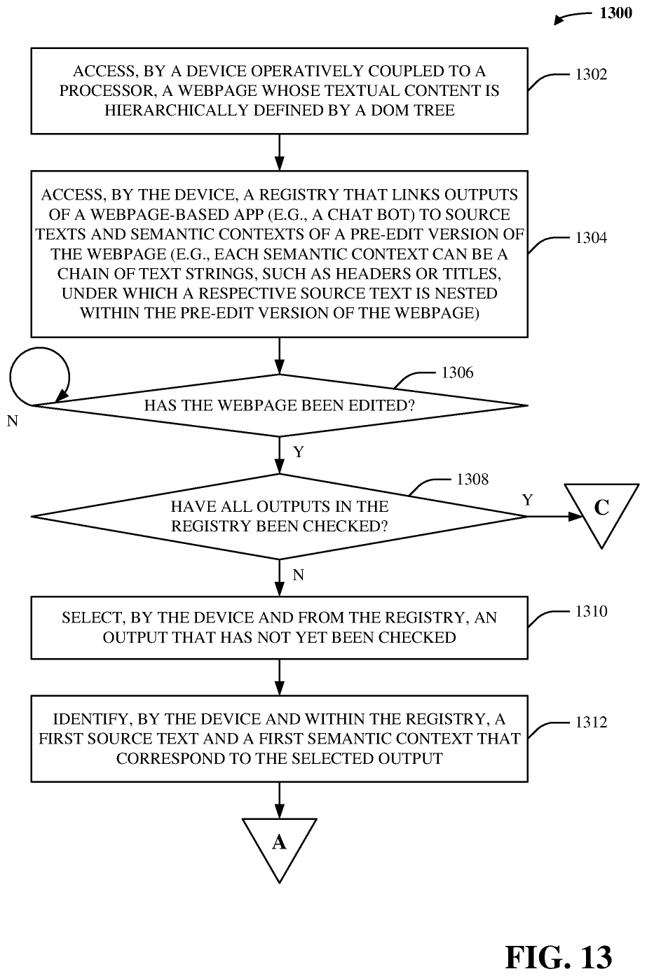

FIGS. 13-16 illustrate flow diagrams of example, non-limiting computer-implemented methods 1300, 1400, 1500, and 1600 that can facilitate context-aware edit management of webpage-based applications in accordance with one or more embodiments described herein. In various cases, the edit management system 102 can facilitate the computer-implemented methods 1300-1600.

First, consider FIG. 13. In various embodiments, act 1302 can include accessing, by a device (e.g., via 116) operatively coupled to a processor (e.g., 112), a webpage (e.g., 104) whose textual content can be hierarchically defined by a DOM tree (e.g., 106).

In various aspects, act 1304 can include accessing, by the device (e.g., via 118), a registry (e.g., 402) that links or correlates outputs (e.g., 110) of a webpage-based app (e.g., 108, which can be a chatbot) to source texts (e.g., 502) and semantic contexts (e.g., 504) of a pre-edit version of the webpage. In various cases, each semantic context can be a chain of text strings, such as headers or titles, under which a respective source text is nested within the pre-edit version of the webpage.

In various instances, act 1306 can include determining, by the device (e.g., via 116), whether the webpage has been edited. If not (e.g., if the webpage has not been edited), the computer-implemented method 1300 can proceed back to act 1306. If so (e.g., if the webpage has been edited), the computer-implemented method 1300 can proceed to act 1308.

In various cases, act 1308 can include determining, by the device (e.g., via 118), whether all outputs in the registry have been checked by the device. If not (e.g., if at least one output has not already been checked by the device), the computer-implemented method 1300 can proceed to act 1310. If so (e.g., if all of the outputs have already been checked by the device), the computer-implemented method 1300 can proceed to act 1602 of the computer-implemented method 1600.

In various aspects, act 1310 can include selecting, by the device (e.g., via 118) and from the registry, an output (e.g., 602) that has not already been checked.

In various instances, act 1312 can include identifying, by the device (e.g., via 118) and within the registry, a first source text (e.g., 604) and a first semantic context (e.g., 606) that correspond to the selected output. The computer-implemented method 1300 can then proceed to act 1402 of the computer-implemented method 1400.

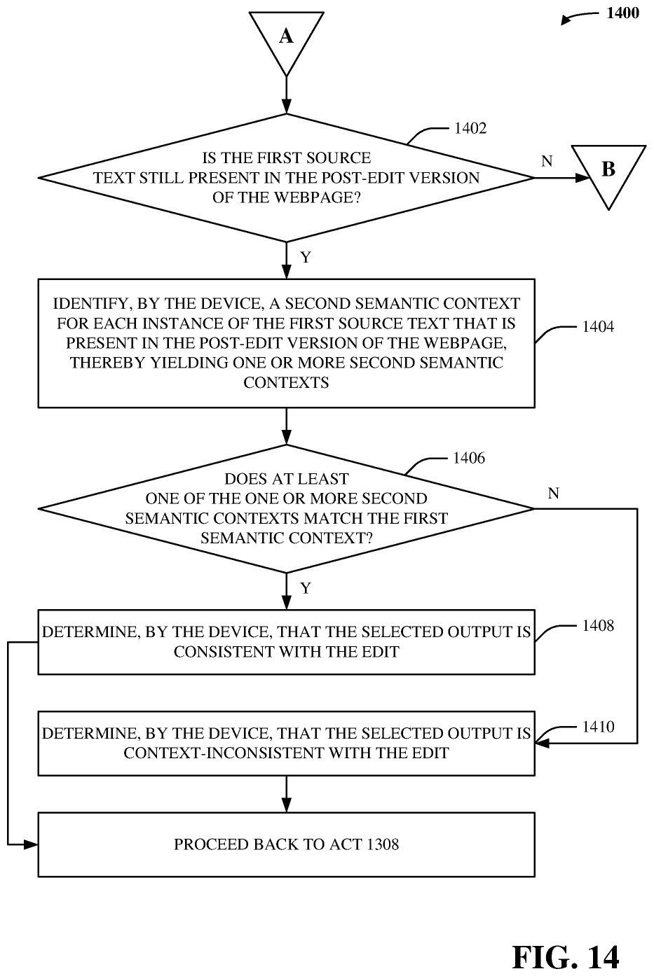

Now, consider FIG. 14. In various embodiments, act 1402 can include determining. by the device (e.g., via 118), whether the first source text is still present in the post-edit version of the webpage. If so (e.g., if at least one instance of the first source text is written somewhere in the post-edit version of the webpage), the computer-implemented method 1400 can proceed to act 1404. If not (e.g., if no instance of the first source text is written anywhere in the post-edit version of the webpage), the computer-implemented method 1400 can instead proceed to act 1502 of the computer-implemented method 1500.

In various aspects, act 1404 can include identifying, by the device (e.g., via 118), a second semantic context (e.g., one of 608) for each instance of the first source text that is present in the post-edit version of the webpage. In various cases, this can yield one or more second semantic contexts (e.g., 608).

In various instances, act 1406 can include determining, by the device (e.g., via 118), whether at least one of the one or more second semantic contexts matches the first semantic context. If so (e.g., if at least one of the one or more second semantic contexts matches the first semantic context), the computer-implemented method 1400 can proceed to act 1408. If not (e.g., if none of the one or more second semantic contexts matches the first semantic context), the computer-implemented method 1400 can instead proceed to act 1410.

In various cases, act 1408 can include determining, by the device (e.g., via 118), that the selected output is consistent with the edit that was detected at act 1306. As shown, the computer-implemented method 1400 can then proceed back to act 1308.

In various aspects, act 1410 can include determining, by the device (e.g., via 118), that the selected output is context-inconsistent with the edit that was detected at act 1306. As shown, the computer-implemented method 1400 can then proceed back to act 1308.

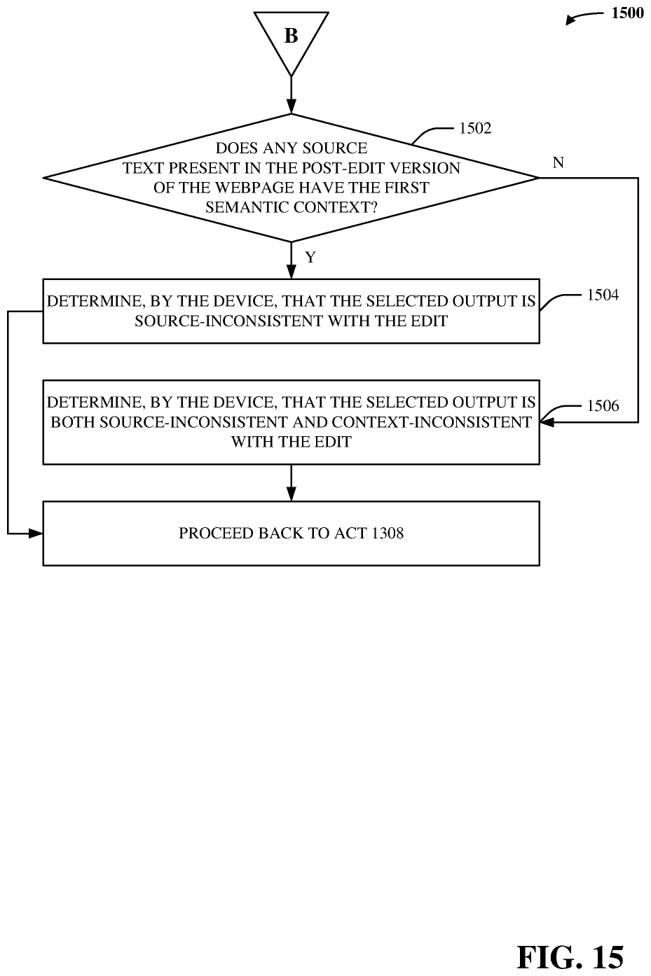

Now, consider FIG. 15. In various embodiments, act 1502 can include determining, by the device (e.g., via 118), whether any source text (e.g., any textual content) within the post-edit version of the webpage has or otherwise corresponds to the first semantic context. If so (e.g., if the first semantic context exists within the post-edit version of the webpage and has some post-edit textual content associated with it), the computer-implemented method 1500 can proceed to act 1504. If not (e.g., if the first semantic context does not exist within the post-edit version of the webpage or otherwise has no post-edit textual content associated with it), the computer-implemented method 1500 can instead proceed to act 1506.

In various cases, act 1504 can include determining, by the device (e.g., via 118), that the selected output is source-inconsistent with the edit that was detected at act 1306. As shown, the computer-implemented method 1500 can then proceed back to act 1308.

In various aspects, act 1506 can include determining, by the device (e.g., via 118), that the selected output is both source-inconsistent and context-inconsistent with the edit that was detected at act 1306. As shown, the computer-implemented method 1500 can then proceed back to act 1308.

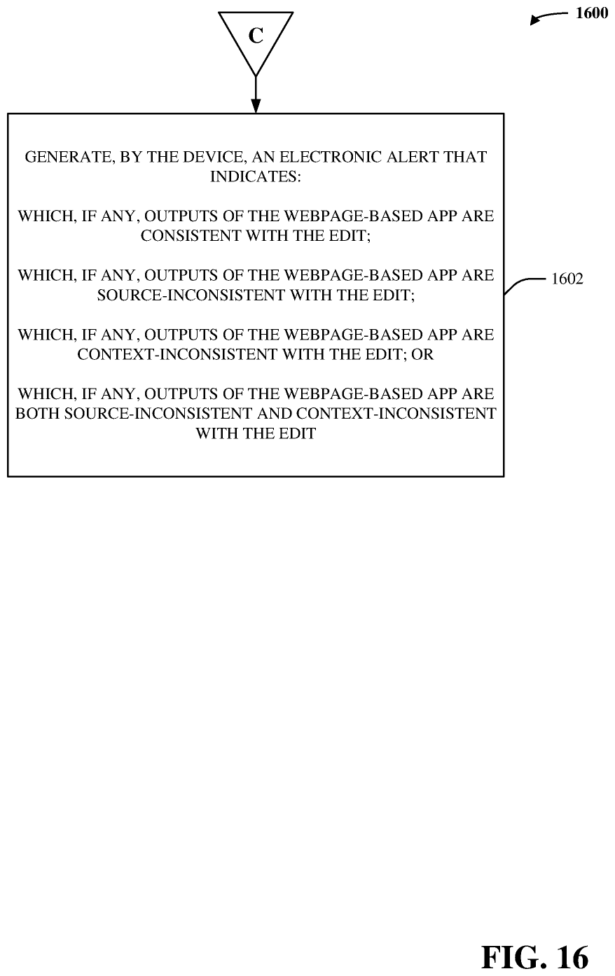

Now, consider FIG. 16. In various embodiments, act 1602 can include generating, by the device (e.g., via 120), an electronic alert (e.g., 1202). In various aspects, the electronic alert can indicate which, if any, outputs of the webpage-based app are consistent with the edit that was detected at act 1306. In various instances, the electronic alert can indicate which, if any, outputs of the webpage-based app are context-inconsistent with the edit that was detected at act 1306. In various cases, the electronic alert can indicate which, if any, outputs of the webpage-based app are source-inconsistent with the edit that was detected at act 1306. In various aspects, the electronic alert can indicate which, if any, outputs of the webpage-based app are both context-inconsistent and source-inconsistent with the edit that was detected at act 1306.

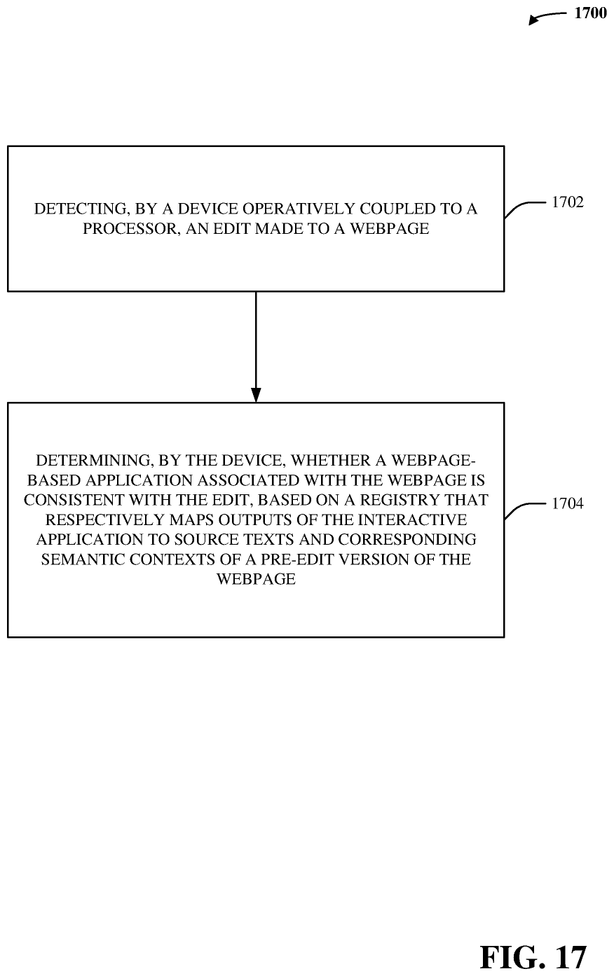

FIG. 17 illustrates a flow diagram of an example, non-limiting computer-implemented method 1700 that can facilitate context-aware edit management of webpage-based applications in accordance with one or more embodiments described herein. In various cases, the edit management system 102 can facilitate the computer-implemented method 1700.

In various embodiments, act 1702 can include detecting, by a device (e.g., via 116) operatively coupled to a processor (e.g., 112), an edit (e.g., 302) made to a webpage (e.g., 104).

In various aspects, act 1704 can include determining, by the device (e.g., via 118), whether a webpage-based application (e.g., 108) associated with the webpage is consistent with the edit, based on a registry (e.g., 402) that respectively maps outputs (e.g., 110) of the webpage-based application to source texts (e.g., 502) and corresponding semantic contexts (e.g., 504) of a pre-edit version of the webpage.

Although not explicitly shown in FIG. 17, the registry can link a first output (e.g., 602) of the webpage-based application to a first source text (e.g., 604) and to a first semantic context (e.g., 606), and the determining whether the webpage-based application is consistent with the edit can comprise: determining, by the device (e.g., via 118), whether the first source text is present within a current version of the webpage.

Although not explicitly shown in FIG. 17, the device can determine that the first source text is present within the current version of the webpage (e.g., as shown in FIG. 6), and the determining whether the webpage-based application is consistent with the edit can comprise: identifying, by the device (e.g., via 118), one or more second semantic contexts (e.g., 608) by traversing a document object model tree (e.g., 106) of the current version of the webpage backward from one or more instances (e.g., m instances) of the first source text; and determining, by the device (e.g., via 118), whether at least one of the one or more second semantic contexts matches the first semantic context. Although not explicitly shown in FIG. 17, the device can determine that at least one of the one or more second semantic contexts matches the first semantic context, and the computer-implemented method 1700 can further comprise: generating, by the device (e.g., via 120), an alert (e.g., 1202) indicating that the first output of the webpage-based application is consistent with the edit. Although not explicitly shown in FIG. 17, the device can instead determine that none of the one or more second semantic contexts matches the first semantic context, and the computer-implemented method 1700 can comprise: generating, by the device (e.g., via 120), an alert indicating that the first output of the webpage-based application is context-inconsistent with the edit.

Although not explicitly shown in FIG. 17, the device can determine that the first source text is not present within the current version of the webpage (e.g., as shown in FIG. 7), and the determining whether the webpage-based application is consistent with the edit can comprise: determining, by the device (e.g., via 118), whether any other source text of the current version of the webpage has the first semantic context. Although not explicitly shown in FIG. 17, the device can determine that another source text of the current version of the webpage has the first semantic context, and the computer-implemented method 1700 can comprise: generating, by the device (e.g., via 120), an alert (e.g., 1202) indicating that the first output of the webpage-based application is source-inconsistent with the edit. Although not explicitly shown in FIG. 17, the device can determine that no other source text of the current version of the webpage has the first semantic context, and the computer-implemented method 1700 can comprise: generating, by the device (e.g., via 120), an alert (e.g., 1202) indicating that the first output of the webpage-based application is context-inconsistent and source-inconsistent with the edit.

Although the herein disclosure mainly describes various embodiments as implementing semantic context to determine whether or not the webpage-based application 108 is consistent with the edit 302, this is a mere non-limiting example for case of explanation and illustration. In various aspects, any other suitable information can be leveraged in addition to semantic context in order to determine whether or not the webpage-based application 108 is consistent with the edit 302. As a non-limiting example, Xpath can, in some cases, be utilized in conjunction with semantic context. That is, the text-context registry 402 can comprise a set of pre-edit Xpaths that can respectively correspond (e.g., in one-to-one fashion) to the set of pre-edit source texts 502, and such pre-edit Xpaths can be used in addition to the set of pre-edit semantic contexts 504 to determine whether or not the webpage-based application 108 is consistent with the edit 302. As yet another non-limiting example, conditional contexts can be implemented in conjunction with semantic context. In particular, each of the set of outputs 110 can be invoked or provided by the webpage-based application 108 in response to a respective set of conditions being satisfied (e.g., whether or not such conditions are satisfied can be based on input from a client that visits the webpage 104). Accordingly, the text-context registry 402 can, in various instances, comprise a set of conditional contexts that respectively correspond to the set of outputs 110, where each conditional context can indicate or represent the set of conditions that are to be satisfied to invoke a respective output. In various cases, such conditional contexts can be utilized in addition to the set of pre-edit semantic contexts 504 to determine whether or not the webpage-based application 108 is consistent with the edit 302.

Although the herein figures and disclosure mainly describe various embodiments as involving a single webpage (e.g., 104), this is a mere non-limiting example for case of explanation and illustration. In various aspects, any suitable number of webpages (e.g., each having its own respective DOM tree) can be implemented. In other words, the set of outputs 110 of the webpage-based application 108 can be collectively sourced from, derived from, or otherwise based on textual content from any suitable number of webpages. In such cases, different ones of the set of pre-edit source texts 502 can come from different ones of those webpages. Accordingly, each of the set of pre-edit source texts 502 can be tagged, in the text-context registry 402, with the uniform resource locator (URL) of whichever webpage from which it was sourced, derived, or based.

Although the herein disclosure mainly describes various embodiments as involving a technician or software engineer making an edit to the webpage 104 and subsequently utilizing the edit management system 102 to determine whether a commensurate edit should be made to the webpage-based application 108, this is a mere non-limiting example for ease of explanation. In various instances, the webpage 104 and the webpage-based application 108 can be maintained, controlled, or overseen by different or separate entities or organizations (e.g., can be not maintained, controlled, or overseen by the same technician or software engineer). In any case, the edit 302 can be made to the webpage 104 by any suitable entity, and whatever entity (e.g., same or different) that is tasked with overseeing, controlling, or maintaining the webpage-based application 108 can utilize the edit management system 102 to determine whether or not the webpage-based application 108 is consistent with the edit 302.

Note that, as described herein, various embodiments of the consistency component 118 can determine not only that any of the set of outputs 110 is inconsistent with the edit 302, but also can determine a specific type of such inconsistency. For example, as mentioned above, the consistency component 118 can determine that any of the set of outputs 110 is context-inconsistent with the edit 302 (e.g., meaning that the pre-edit source text of that output is still present in the webpage 104 but no longer has its corresponding pre-edit semantic context). As another example, as mentioned above, the consistency component 118 can determine that any of the set of outputs 110 is source-inconsistent with the edit 302 (e.g., meaning that the pre-edit source text is no longer present in the webpage 104, but that the pre-edit semantic context of that output is nevertheless present with different textual content in the webpage 104). As yet another example, as mentioned above, the consistency component 118 can determine that any of the set of outputs 110 is both source-inconsistent and context-inconsistent with the edit 302 (e.g., meaning that neither the pre-edit source text nor the pre-edit semantic context of that output are present any longer in the webpage 104). In various embodiments, such specific types of inconsistencies can be leveraged by the alert component 120 to help prioritize alerts or to otherwise help suggest or recommend potential solutions.

As a non-limiting example, and referring back to FIG. 7, suppose that the consistency component 118 determines that the output 602 is source-inconsistent with the edit 302. In such case, the alert component 120 can indicate, in the electronic alert 1202, that the output 602 has been determined to be source-inconsistent and can assign to the output 602 an intermediate or moderate level of maintenance or repair priority. Moreover, in such case, the alert component 120 can suggest or recommend, in the electronic alert 1202, that substantive content of the output 602 (rather than a conditional context of the output 602) might warrant being edited commensurately with the edit 302 (e.g., commensurately with whatever other textual content was found to correspond to the pre-edit semantic context 606). In other words, the alert component 120 can suggest or recommend, in the electronic alert 1202, that whatever other textual content was found to correspond to the pre-edit semantic context 606 be treated as the new source text for the output 602 moving forward (e.g., can suggest or recommend that such other textual content should replace the pre-edit source text 604).

As another non-limiting example, and referring back to FIG. 6, suppose that the consistency component 118 determines that the output 602 is context-inconsistent with the edit 302. In such case, the alert component 120 can indicate, in the electronic alert 1202, that the output 602 has been determined to be context-inconsistent and can assign to the output 602 an intermediate or moderate level of maintenance or repair priority. In some cases, the alert component 120 can pinpoint, in the electronic alert 1202, which specific text strings of the pre-edit semantic context 606 were not located within the webpage 104 after the edit 302. That is, the alert component 120 can, in such cases, emphasize or otherwise draw attention to which specific text strings of the pre-edit semantic context 606 (and thus to which specific document objects in the DOM tree 106) were changed or altered by the edit 302. Furthermore, in yet other cases, the alert component 120 can suggest or recommend, in the electronic alert 1202, that a conditional context of the output 602 (rather than substantive content of the output 602) might warrant being edited commensurately with the edit 302 (e.g., commensurately with any of the set of post-edit semantic contexts 608). In other words, the alert component 120 can suggest or recommend, in the electronic alert 1202, that any of the set of post-edit semantic contexts 608 be treated as the new semantic context for the output 602 moving forward (e.g., can suggest or recommend that the pre-edit semantic context 606 be replaced with one of the set of post-edit semantic contexts 608).

As even another non-limiting example, suppose that the consistency component 118 determines that the output 602 is both source-inconsistent and context-inconsistent with the edit 302. In such case, the alert component 120 can indicate, in the electronic alert 1202, that the output 602 has been determined to be both source-inconsistent and context-inconsistent and can assign to the output 602 a high level of maintenance or repair priority. Further still, in such case, the alert component 120 can suggest or recommend, in the electronic alert 1202, that both substantive content and a conditional context of the output 602 might warrant being edited commensurately with the edit 302.

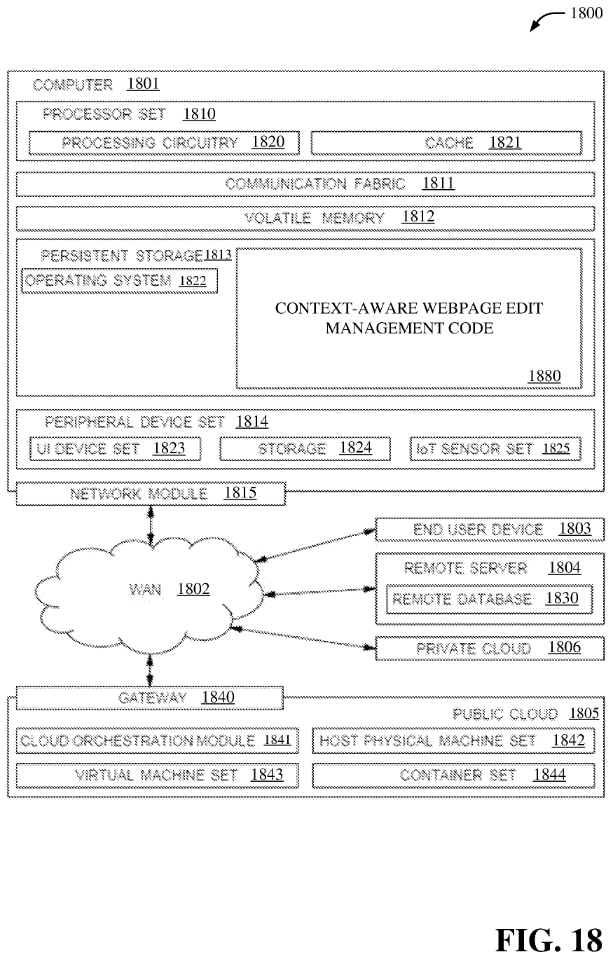

FIG. 18 and the following discussion are intended to provide a brief, general description of a suitable computing environment 1800 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1800 contains an example of an environment for the execution of at least some of the computer code involved in performing the inventive methods, such as context-aware webpage edit management code 1880. In addition to block 1880, computing environment 1800 includes, for example, computer 1801, wide area network (WAN) 1802, end user device (EUD) 1803, remote server 1804, public cloud 1805, and private cloud 1806. In this embodiment, computer 1801 includes processor set 1810 (including processing circuitry 1820 and cache 1821), communication fabric 1811, volatile memory 1812, persistent storage 1813 (including operating system 1822 and block 1880, as identified above), peripheral device set 1814 (including user interface (UI), device set 1823, storage 1824, and Internet of Things (IoT) sensor set 1825), and network module 1815. Remote server 1804 includes remote database 1830. Public cloud 1805 includes gateway 1840, cloud orchestration module 1841, host physical machine set 1842, virtual machine set 1843, and container set 1844.

COMPUTER 1801 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1830. As is well understood in the art of computer technology, and depending upon the technology, performance of a computer-implemented method can be distributed among multiple computers or between multiple locations. On the other hand, in this presentation of computing environment 1800, detailed discussion is focused on a single computer, specifically computer 1801, to keep the presentation as simple as possible. Computer 1801 can be located in a cloud, even though it is not shown in a cloud in FIG. 18. On the other hand, computer 1801 is not required to be in a cloud except to any extent as can be affirmatively indicated.

PROCESSOR SET 1810 includes one, or more, computer processors of any type now known or to be developed in the future. Processing circuitry 1820 can be distributed over multiple packages, for example, multiple, coordinated integrated circuit chips. Processing circuitry 1820 can implement multiple processor threads or multiple processor cores. Cache 1821 is memory that is located in the processor chip package(s) and is typically used for data or code that should be available for rapid access by the threads or cores running on processor set 1810. Cache memories are typically organized into multiple levels depending upon relative proximity to the processing circuitry. Alternatively, some, or all, of the cache for the processor set can be located “off chip.” In some computing environments, processor set 1810 can be designed for working with qubits and performing quantum computing.

Computer readable program instructions are typically loaded onto computer 1801 to cause a series of operational steps to be performed by processor set 1810 of computer 1801 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1821 and the other storage media discussed below. The program instructions, and associated data, are accessed by processor set 1810 to control and direct performance of the inventive methods. In computing environment 1800, at least some of the instructions for performing the inventive methods can be stored in block 1880 in persistent storage 1813.

COMMUNICATION FABRIC 1811 is the signal conduction path that allows the various components of computer 1801 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1812 is any type of volatile memory now known or to be developed in the future. Examples include dynamic type random access memory (RAM) or static type RAM. Typically, the volatile memory is characterized by random access, but this is not required unless affirmatively indicated. In computer 1801, the volatile memory 1812 is located in a single package and is internal to computer 1801, but, alternatively or additionally, the volatile memory can be distributed over multiple packages or located externally with respect to computer 1801.

PERSISTENT STORAGE 1813 is any form of non-volatile storage for computers that is now known or to be developed in the future. The non-volatility of this storage means that the stored data is maintained regardless of whether power is being supplied to computer 1801 or directly to persistent storage 1813. Persistent storage 1813 can be a read only memory (ROM), but typically at least a portion of the persistent storage allows writing of data, deletion of data and re-writing of data. Some familiar forms of persistent storage include magnetic disks and solid-state storage devices. Operating system 1822 can take several forms, such as various known proprietary operating systems or open-source Portable Operating System Interface type operating systems that employ a kernel. The code included in block 1880 typically includes at least some of the computer code involved in performing the inventive methods.

PERIPHERAL DEVICE SET 1814 includes the set of peripheral devices of computer 1801. Data communication connections between the peripheral devices and the other components of computer 1801 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1823 can include components such as a display screen, speaker, microphone, wearable devices (such as goggles and smart watches), keyboard, mouse, printer, touchpad, game controllers, and haptic devices. Storage 1824 is external storage, such as an external hard drive, or insertable storage, such as an SD card. Storage 1824 can be persistent or volatile. In some embodiments, storage 1824 can take the form of a quantum computing storage device for storing data in the form of qubits. In embodiments where computer 1801 is required to have a large amount of storage (for example, where computer 1801 locally stores and manages a large database) then this storage can be provided by peripheral storage devices designed for storing large amounts of data, such as a storage area network (SAN) that is shared by multiple, geographically distributed computers. IoT sensor set 1825 is made up of sensors that can be used in Internet of Things applications. For example, one sensor can be a thermometer and another sensor can be a motion detector.

NETWORK MODULE 1815 is the collection of computer software, hardware, and firmware that allows computer 1801 to communicate with other computers through WAN 1802. Network module 1815 can include hardware, such as modems or Wi-Fi signal transceivers, software for packetizing or de-packetizing data for communication network transmission, or web browser software for communicating data over the internet. In some embodiments, network control functions and network forwarding functions of network module 1815 are performed on the same physical hardware device. In other embodiments (for example, embodiments that utilize software-defined networking (SDN)), the control functions and the forwarding functions of network module 1815 are performed on physically separate devices, such that the control functions manage several different network hardware devices. Computer readable program instructions for performing the inventive methods can typically be downloaded to computer 1801 from an external computer or external storage device through a network adapter card or network interface included in network module 1815.

WAN 1802 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1803 is any computer system that is used and controlled by an end user (for example, a customer of an enterprise that operates computer 1801) and can take any of the forms discussed above in connection with computer 1801. EUD 1803 typically receives helpful and useful data from the operations of computer 1801. For example, in a hypothetical case where computer 1801 is designed to provide a recommendation to an end user, this recommendation would typically be communicated from network module 1815 of computer 1801 through WAN 1802 to EUD 1803. In this way, EUD 1803 can display, or otherwise present, the recommendation to an end user. In some embodiments, EUD 1803 can be a client device, such as thin client, heavy client, mainframe computer or desktop computer.

REMOTE SERVER 1804 is any computer system that serves at least some data or functionality to computer 1801. Remote server 1804 can be controlled and used by the same entity that operates computer 1801. Remote server 1804 represents the machine(s) that collect and store helpful and useful data for use by other computers, such as computer 1801. For example, in a hypothetical case where computer 1801 is designed and programmed to provide a recommendation based on historical data, then this historical data can be provided to computer 1801 from remote database 1830 of remote server 1804.

PUBLIC CLOUD 1805 is any computer system available for use by multiple entities that provides on-demand availability of computer system resources or other computer capabilities, especially data storage (cloud storage) and computing power, without direct active management by the scale. The direct and active management of the computing resources of public cloud 1805 is performed by the computer hardware or software of cloud orchestration module 1841. The computing resources provided by public cloud 1805 are typically implemented by virtual computing environments that run on various computers making up the computers of host physical machine set 1842, which is the universe of physical computers in or available to public cloud 1805. The virtual computing environments (VCEs) typically take the form of virtual machines from virtual machine set 1843 or containers from container set 1844. It is understood that these VCEs can be stored as images and can be transferred among and between the various physical machine hosts, either as images or after instantiation of the VCE. Cloud orchestration module 1841 manages the transfer and storage of images, deploys new instantiations of VCEs and manages active instantiations of VCE deployments. Gateway 1840 is the collection of computer software, hardware and firmware allowing public cloud 1805 to communicate through WAN 1802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1806 is similar to public cloud 1805, except that the computing resources are only available for use by a single enterprise. While private cloud 1806 is depicted as being in communication with WAN 1802, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1805 and private cloud 1806 are both part of a larger hybrid cloud.

The herein disclosure describes non-limiting examples of various embodiments. For case of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on a computer, partly on a computer, as a stand-alone software package, partly on a computer or partly on a remote computer or entirely on the remote computer or server. In the latter scenario, the remote computer can be connected to a computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

While the subject matter has been described above in the general context of computer-executable instructions of a computer program product that runs on a computer or computers, those skilled in the art will recognize that the one or more embodiments herein also can be implemented at least partially in parallel with one or more other program modules. Generally, program modules include routines, programs, components or data structures that perform particular tasks or implement particular abstract data types. Moreover, the aforedescribed computer-implemented methods can be practiced with other computer system configurations, including single-processor or multiprocessor computer systems, mini-computing devices, mainframe computers, as well as computers, hand-held computing devices (e.g., PDA, phone), or microprocessor-based or programmable consumer or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches or gates, in order to optimize space usage or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Also, the described memory components of systems or computer-implemented methods herein are intended to include, without being limited to including, these or any other suitable types of memory.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A system, comprising:
a memory that stores computer executable components; and
a processor that executes at least one of the computer-executable components that:
detects an edit made to a webpage comprising selectively displayable source texts and selectively displayable semantic context texts, wherein the selectively displayable source texts are mapped to respective semantic contexts in a hierarchical data structure, wherein the respective semantic context comprises a path amongst a subset of the selectively displayable semantic context texts from a root of the hierarchical data structure to the selectively displayable source text; and
determines whether response texts of a webpage-based conversational application associated with the webpage are consistent with the edit, based on a registry that respectively maps the response texts of the webpage-based conversational application to pre-edit selectively displayable source texts and corresponding pre-edit semantic contexts of a pre-edit version of the webpage.

2. The system of claim 1, wherein the registry links a response text of the webpage-based conversational application to a pre-edit selectively displayable source text and to a pre-edit semantic context; and wherein the at least one of the computer executable components further:
determines whether the pre-edit selectively displayable source text is present within a current version of the webpage.

3. The system of claim 2, wherein the at least one of the computer executable components further:
determines that the pre-edit selectively displayable source text is present within the current version of the webpage;
identifies one or more semantic contexts in the current version of the webpage by traversing a document object model tree of the current version of the webpage backward from one or more instances of the pre-edit selectively displayable source text; and
determines whether at least one of the one or more semantic contexts matches the pre-edit semantic context.

4. The system of claim 3, wherein the at least one of the computer executable components further:
determines that at least one of the one or more semantic contexts matches the pre-edit semantic context; and
generates an alert indicating that the response text of the webpage-based conversational application is consistent with the edit.

5. The system of claim 3, wherein the at least one of the computer executable components further:
determines that none of the one or more semantic contexts matches the pre-edit semantic context; and
generates an alert indicating that the response text of the webpage-based conversational application is context-inconsistent with the edit.

6. The system of claim 2, wherein the at least one of the computer executable components further:
determines that the pre-edit selectively displayable source text is not present within the current version of the webpage; and
determines whether any other source text of the current version of the webpage is mapped to a semantic context that matches the pre-edit semantic context.

7. The system of claim 6, wherein the at least one of the computer executable components further:
determines that another pre-edit selectively displayable source text of the current version of the webpage is mapped to the semantic context that matches the pre-edit semantic context; and
generates an alert indicating that the response text of the webpage-based conversational application is source-inconsistent with the edit.

8. The system of claim 6, wherein the at least one of the computer executable components further:
determines that no other pre-edit selectively displayable source text of the current version of the webpage is mapped to the semantic context that matches the pre-edit semantic context; and
generates an alert indicating that the response text of the webpage-based conversational application is context-inconsistent and source-inconsistent with the edit.

9. A computer-implemented method, comprising:
detecting, by a device operatively coupled to a processor, an edit made to a webpage comprising selectively displayable source texts and selectively displayable semantic context texts, wherein the selectively displayable source texts are mapped to respective semantic contexts in a hierarchical data structure, wherein the respective semantic context comprises a path amongst a subset of the selectively displayable semantic context texts from a root of the hierarchical data structure to the selectively displayable source text; and
determining, by the device, whether a webpage-based chatbot application associated with the webpage is consistent with the edit, based on a registry that respectively maps response texts of the webpage-based chatbot application to pre-edit selectively displayable source texts and corresponding pre-edit semantic contexts of a pre-edit version of the webpage.

10. The computer-implemented method of claim 9, wherein the registry links a response text of the webpage-based chatbot application to a pre-edit selectively displayable source text and to a pre-edit semantic context, and wherein the determining whether the webpage-based chatbot application is consistent with the edit comprises:
determining, by the device, whether the pre-edit selectively displayable source text is present within a current version of the webpage.

11. The computer-implemented method of claim 10, wherein the device determines that the pre-edit selectively displayable source text is present within the current version of the webpage, and wherein the determining whether the webpage-based chatbot application is consistent with the edit comprises:
identifying, by the device, one or more semantic contexts in the current version of the webpage by traversing a document object model tree of the current version of the webpage backward from one or more instances of the pre-edit selectively displayable source text; and
determining, by the device, whether at least one of the one or more semantic contexts matches the pre-edit semantic context.

12. The computer-implemented method of claim 11, wherein the device determines that at least one of the one or more semantic contexts matches the pre-edit semantic context, and further comprising:
generating, by the device, an alert indicating that the response text of the webpage-based chatbot application is consistent with the edit.

13. The computer-implemented method of claim 11, wherein the device determines that none of the one or more semantic contexts matches the pre-edit semantic context text, and further comprising:
generating, by the device, an alert indicating that the response text of the webpage-based chatbot application is context-inconsistent with the edit.

14. The computer-implemented method of claim 10, wherein the device determines that the pre-edit selectively displayable source text is not present within the current version of the webpage, and wherein the determining whether the webpage-based chatbot application is consistent with the edit comprises:
determining, by the device, whether any other pre-edit selectively displayable source text of the current version of the webpage is mapped to a semantic context that matches the pre-edit semantic context.

15. The computer-implemented method of claim 14, wherein the device determines that another pre-edit selectively displayable source text of the current version of the webpage is mapped to the semantic context that matches the pre-edit semantic context, and further comprising:
generating, by the device, an alert indicating that the response text of the webpage-based chatbot application is source-inconsistent with the edit.

16. The computer-implemented method of claim 14, wherein the device determines that no other pre-edit selectively displayable source text of the current version of the webpage is mapped to the semantic context that matches the pre-edit semantic context, and further comprising:
generating, by the device, an alert indicating that the response text of the webpage-based chatbot application is context-inconsistent and source-inconsistent with the edit.

17. A computer program product for facilitating context-aware edit management of webpage-based user interface applications, the computer program product comprising a non-transitory computer-readable memory having program instructions embodied therewith, the program instructions executable by a processor to cause the processor to:
detect an edit made to a webpage comprising selectively displayable source texts and selectively displayable semantic context texts, wherein the selectively displayable source texts are mapped to respective semantic contexts in a hierarchical data structure, wherein the respective semantic context comprises a path amongst a subset of the selectively displayable semantic context texts from a root of the hierarchical data structure to the selectively displayable source text; and
determine whether response texts of a webpage-based user interface application associated with the webpage is consistent with the edit, based on a registry that respectively maps the response texts of the webpage-based user interface application to pre-edit selectively displayable source texts and corresponding pre-edit semantic contexts of a pre-edit version of the webpage.

18. The computer program product of claim 17, wherein the registry links a response text of the webpage-based user interface application to a pre-edit selectively displayable source text and to a pre-edit semantic context, and wherein the program instructions are further executable to cause the processor to:
determine whether the pre-edit selectively displayable source text is present within a current version of the webpage.

19. The computer program product of claim 18, wherein the processor determines that the pre-edit selectively displayable source text is present within the current version of the webpage, and wherein the program instructions are further executable to cause the processor to:
identify one or more semantic contexts in the current version of the webpage by traversing a document object model tree of the current version of the webpage backward from one or more instances of the pre-edit selectively displayable source text; and
determine whether at least one of the one or more semantic contexts texts matches the pre-edit semantic context.

20. The computer program product of claim 19, wherein the processor determines that at least one of the one or more semantic contexts matches the pre-edit semantic context, and wherein the program instructions are further executable to cause the processor to:
generate an alert indicating that the response text of the webpage-based user interface application is consistent with the edit.
